(19) United States
(12) Patent Application Publication
(10) Pub. No.: US 2005/0033698 A1
(43) Pub. Date: Feb. 10, 2005

(54) Apparatus and method for the exchange of rights and responsibilites between group members

(76) Inventor: Colin D. Chapman, Seattle, WA (US)

Correspondence Address: DAVIS WRIGHT TREMAINE, LLP, 2600 CENTURY SQUARE, 1501 FOURTH AVENUE, SEATTLE, WA, 98101-1688, US

(21) Appl. No.: 10/913,060

(22) Filed: Aug. 5, 2004

Related U.S. Application Data
(60) Provisional application No. 60/492,839, filed on Aug. 5, 2003.

(51) Int. Cl. G06F 17/60

(52) U.S. Cl. 705/51

(57) ABSTRACT

An exchange of rights and responsibilities between group members uses member qualifications and requirements that are entered into a record associated with each group member along with contact information, as well as qualifications and requirements and the like that are entered into a record associated with each right and responsibility. A group member may request an exchange of rights or responsibilities with another group member. The system analyzes the qualifications and requirements associated with the particular right or responsibility and the qualifications and requirements of group members to determine a pool of suitable candidates. Messages are automatically sent to suitable candidates requesting the exchange. The exchange request may occur via a variety of different communication channels. If an exchange is arranged, the system will automatically send confirmation and/or authorization messages to various group members and may automatically alter the schedule to reflect the exchange.

### BACKGROUND OF THE INVENTION

1. Field of the Invention

The present disclosure relates generally to the exchange of rights and responsibilities between group members and, more particularly, to an apparatus and method for use of a computer network to exchange rights and responsibilities between group members.

2. Description of the Related Art

Job scheduling has always been a difficult task. Prior to the use of computers, a supervisor or other administrator had to create a work schedule by hand. With the introduction of computer systems, work scheduling became somewhat less tedious. However, scheduling conflicts are bound to occur whenever a schedule is generated. For example, an individual scheduled to work Monday through Friday may be unable to work on a particular Friday due to a previous commitment which was not accounted for when the original schedule was generated.

In the past, the individual employee would generally be responsible for finding a suitable individual to substitute for the employee on that day, and the employee and the suitable replacement would often enter into negotiations regarding an exchange of work assignments. Alternatively, the employee may go to the supervisor or administrator and that supervisor would be left with the task of finding a suitable replacement and negotiating an exchange of work assignments between the employees.

With the introduction of computer systems, creation of a schedule became less tedious. However, finding an appropriate substitute for an unavailable employee and negotiating an exchange of work assignments between the employees remains a tedious process. The individual employee or supervisor/administrator must first determine who is both available and qualified to serve as a substitute on a particular day, must then contact the available and qualified individuals to determine whether any of the individuals are willing to serve as a substitute, and must finally negotiate an exchange of work responsibilities between the employees. If an individual willing to exchange work responsibilities is located, the supervisor/administrator must alter the computer generated schedule to reflect the changes.

With currently available systems, locating substitute employees and negotiating exchanges of work assignments remain tedious and time consuming tasks. Therefore, it can be appreciated that there is a significant need for a system and method for automating the substitution and exchange process. The present invention provides this and other advantages as will be apparent from the following detailed description and accompanying figures.

### BRIEF DESCRIPTION OF THE SEVERAL VIEWS OF THE DRAWING(S)

FIG. 1 is a functional block diagram of a computer network used to implement the system described herein.

FIG. 2 is a functional block diagram of a typical computer system coupled to the computer network of FIG. 1.

FIG. 3 is a flow chart illustrating the operation of the computer network of FIG. 1 to enter a new group member and the assignment of qualifications and requirements to the group member.

FIG. 4 is a flow chart illustrating the operation of the system of FIG. 1 to create a new right or responsibility and the assignment of qualifications and requirements to the right or responsibility.

FIG. 5 is a flow chart illustrating the operation of the system of FIG. 1 to determine a pool of suitable substitute candidates for the exchange of rights or responsibilities.

FIG. 6 is a flow chart illustrating the operation of the system of FIG. 1 to create exchanges between group members.

FIG. 7 is a flow chart illustrating the operation of the system of FIG. 1 to arrange an exchange of rights or responsibilities and to resolve conflicts and generate a new schedule if a suitable exchange occurs.

FIGS. 8-23 are a series of screen-displays illustrating communications between a group member requesting an exchange of rights or responsibilities and other group members who make up the suitable candidate pool.

FIG. 24 is a flow chart illustrating the operation of the system of FIG. 1 to determine which exchange requests shall be sent to an originating group member and which shall be sent to members of a suitable candidate pool, and in what sequence they should be sent.

### DETAILED DESCRIPTION OF THE INVENTION

The techniques described herein permit a great deal of automation in the employee substitution and exchange process described above. However, the techniques described herein are more broadly applicable to an exchange of rights and responsibilities between group members. In an employee substitution and exchange scenario, group members may be other employees and the automated system identifies suitable substitutes in an exchange of responsibilities (i.e., a substitution or exchange of work responsibilities). However, in another scenario, a group member may have certain rights he wishes to exchange with another group member. For example, an individual may have reserved time in a laboratory for simulation or testing, but is unable to utilize the reserved time due to unforeseen difficulties. In such a scenario, group members may be other laboratory users and the automated system identifies suitable substitutes in an exchange of rights (i.e., a substitution or exchange of reserved lab time). Although specific examples will be provided herein, those skilled in the art will appreciate that the principles of the invention may be broadly applied and that the invention is not limited merely to the examples provided.

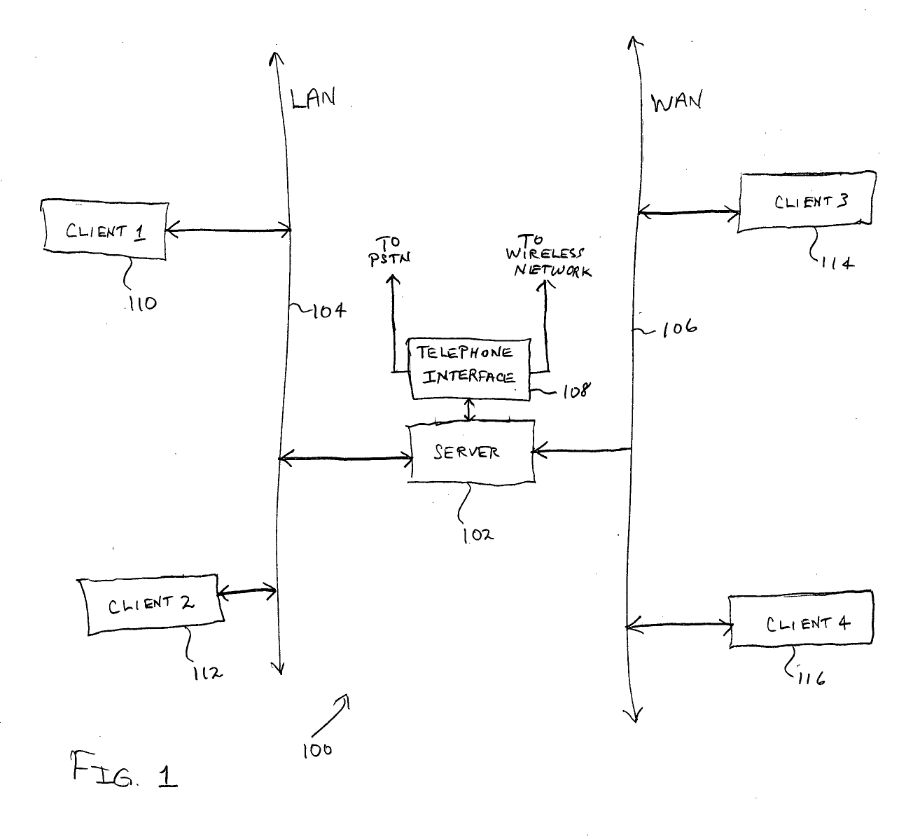

In one example, the invention is embodied in a system 100 illustrated in the functional block diagram of FIG. 1. The system 100 includes a server 102, which is part of a typical client-server architecture. Those skilled in the art will appreciate that the terms “client” and “server” are merely descriptive of a relationship between multiple processors. In a typical scenario, a client is a computer or processor requesting information or servicing while a server is the computer or processor that provides the information or servicing. However, that server may, in turn, be considered a client if it requests information or servicing from yet another computer. Thus, the client and server are used herein merely for convenience in describing the roles played by various computers. Other well-known computer architectures, such as a peer-to-peer architecture may also be employed to implement the system 100.

The server 102 is coupled to a local area network (LAN) 104 and a wide-area network (WAN) 106. The LAN 104 may be readily implemented by known technologies, such as Ethernet, and provide an implementation that may be useful within a large organization with multiple computers, such as an educational facility. The WAN 106 may be readily implemented using known technologies, such as the Internet.

A number of client computers may be coupled to the LAN 104 and the WAN 106. FIG. 1 illustrates a client 110 and a client 112 coupled to the server 102 via the LAN 104. A client 114 and a client 116 are similarly coupled to the server 102 via the WAN 106. Those skilled in the art will appreciate that many more computers may be coupled to the server 102 via the LAN 104 and/or the WAN 106.

The communication protocols between the clients 110-112 and the server 102 via the LAN 104 are well known in the art and need not be described in greater detail herein. Similarly, conventional communication protocols are used for communication between the clients 114-116 and the server 102 via the WAN 106. These communication protocols and details are well known to those of ordinary skill in the art and need not be described herein.

The server 102 is also coupled to a telephone interface 108 to permit contact with users via telephone. The telephone interface 108 may be coupled to a wireless telephone network or to a conventional public switched telephone network (PSTN) in a known fashion. The telephone interface 108 permits telephonic communication between group members.

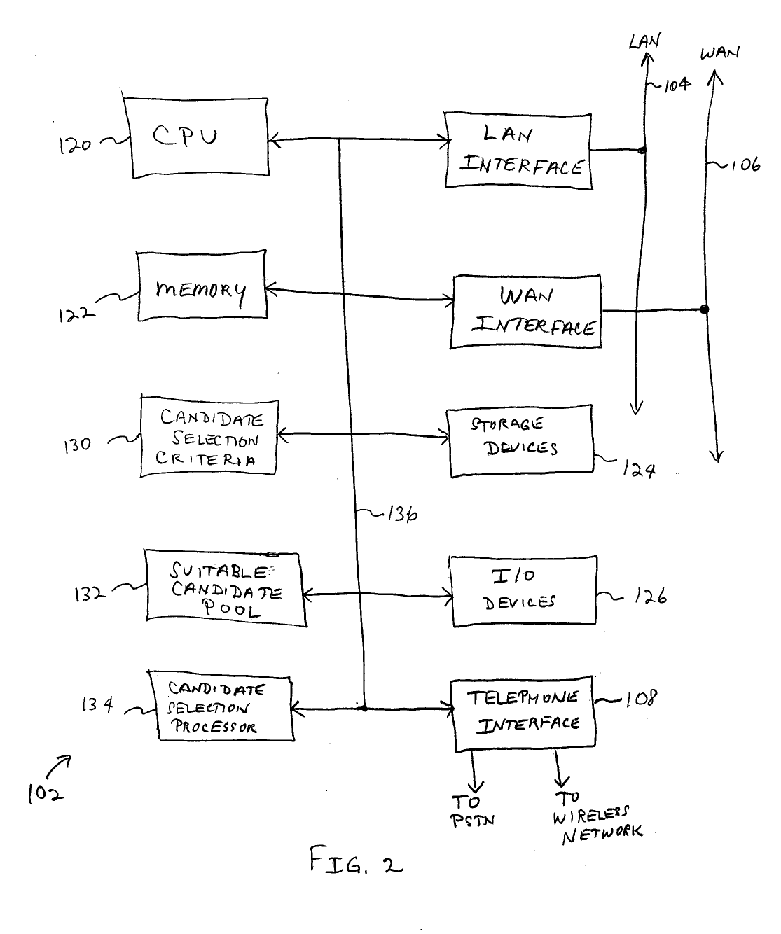

FIG. 2 is a functional block diagram illustrating an example implementation of the server 102. The server 102 comprises a central processing unit (CPU) 120, which controls operation of the server 102. Those skilled in the art will appreciate that the CPU 120 is intended to encompass any processing device capable of operating the server 102. This includes microprocessors, imbedded controllers, application-specific integrated circuits (ASICs), digital signal processors (DSPs), state machines, dedicated discrete hardware, and the like. The present invention is not limited by the specific hardware component(s) selected to implement the CPU 120.

The server 102 also includes a memory 122, which may include both read-only memory (ROM) and random access memory (RAM). The memory 122 provides instructions and data to the CPU 120. A portion of the memory 122 may also include nonvolatile random access memory.

The server 102 also includes other conventional computer components, such as storage devices 124 and input/output (I/O) devices 126. Storage devices 124 may include, by way of example, a hard disk drive, floppy disk drive, CD-ROM, DVD, and the like. The CD-ROM and DVD may be implemented as read-only devices or may have read/write capability.

I/O devices 126 include components, such as a display, keyboard, mouse, touch pad, and the like. The operation of the storage devices 124 and I/O devices 126 are well known and need not be described herein except as it relates to the specific implementation of the system 100.

Also shown in FIG. 2 is a candidate selection criteria 130 and a suitable candidate pool 132. As will be described in greater detail below, the candidate selection criteria 130 is a list of criteria or other requirements and qualifications that are used to select potential candidates for the exchange of rights and responsibilities. Potential candidates that meet the candidate selection criteria are placed in the suitable candidate pool 132 for possible use in the exchange of rights and responsibilities.

A candidate selection processor 134 applies the candidate selection criteria 130 to a list of all possible candidates for the exchange of rights and responsibilities and selects candidates that meet the criteria. Those candidates meeting the candidate selection criteria 130 are placed in the suitable candidate pool 132. As will be described in greater detail below, the candidate selection processor 134 then generates a list of all valid exchanges of rights or responsibilities between the group members seeking a replacement and the group members in the suitable candidate pool 132. The candidate selection processor 134 then communicates with candidates identified in the suitable candidate pool 132 in an effort to arrange the required exchange of rights and responsibilities. Finally, the candidate selection processor 134 obtains confirmation/approvals and generates or regenerates schedules to indicate exchanges that have occurred.

Although FIG. 2 illustrates these processes as performed solely by the candidate selection processor 134, those skilled in the art will recognize that the system 100 may have separate processors with one processor for candidate selection, another for generating valid exchanges, another for obtaining confirmations/approvals, and another for (re)generating schedules. The present invention is not limited by the specific implementation of functions by the candidate selection processor 134 or other multiple processors that may be implemented within the system 100.

The various components described above are interconnected by a bus system 136. The bus system 136 may include a data bus, power bus, control bus, and the like. However, for the sake of clarity, the various busses are illustrated in FIG. 2 as the bus system 136.

Those skilled in the art will appreciate that the functional block diagram of FIG. 2 is intended to illustrate the server 102 at a functional level, and that some functional blocks or portions thereof may be implemented by a set of software instructions stored in the memory 122 and executed by the CPU 120. For example, the candidate selection processor 134 may be implemented by program steps stored in the memory 122 and executed by the CPU 120. However, the candidate selection processor 134 is illustrated in the functional block diagram of FIG. 2 because it performs a separate function. If the candidate selection processor 134 is broken down into separate functions, such as candidate selection, generating valid exchanges, obtaining confirmations/approvals, and (re)generating schedules, those various processes may also be implemented by program steps stored in the memory 122 and executed by the CPU 120.

The operation of the system 100 may now be explained in greater detail. As noted above, the candidate selection processor 134 is first used in conjunction with the candidate selection criteria 130 to select possible substitute candidates for addition to the suitable candidate pool 132. To perform this action, it is necessary to create an account for the group. A “group” is defined as any entity or organization that controls a set of rights or demands a set of responsibilities. For example, an individual business, factory, school, or the like may be considered a group. Group members are any individuals associated with a group who utilize the group's rights or fulfill the group's responsibilities. For example, an individual employee, volunteer, customer, or the like may be considered a group member. A member may be associated with one or more groups. The term “rights” refers to any role or service that a group controls and allows group members to utilize. For example, a group may control a particular testing facility and may offer group members rights to utilize that facility at certain dates and times. Group members assigned such rights may exchange their rights with other group members. The term “responsibilities” refers to any role or service that a group demands and expects group members to fulfill. For example, a group may demand that a set of work shifts be covered by group members and may therefore assign group members the responsibility of fulfilling particular shifts. Group members assigned to such responsibilities may exchange their responsibilities with other group members.

The term “attributes” may be used herein to refer to characteristics that comprise the qualifications (i.e., skills, capabilities) and the requirements (i.e., needs, desires) of rights, responsibilities and group members. The term “qualifications” refers to one or more attributes that may be associated with a group member, that represent the skills or capabilities possessed by that group member. Qualifications enable a group member to satisfy the “requirements” associated with a right or responsibility, thereby enabling the group member to utilize the right or fulfill the responsibility. Additionally, the term “qualifications” refers to one or more attributes that may be associated with a right or responsibility, that represent the skills or capabilities possessed by that right or responsibility. Qualifications enable a right or responsibility to satisfy the “requirements” associated with a group member, thereby enabling the group member to utilize the right or fulfill the responsibility.

The term “requirements” refers to one or more attributes that may be associated with a group member, that represent the needs or desires possessed by that group member. Requirements define the minimum “qualifications” that must be associated with a particular right or responsibility in order for the group member to utilize the right or fulfill the responsibility. Additionally, the term “requirements” refers to one or more attributes that may be associated with a right or responsibility, that represent the needs or desires possessed by the right or responsibility. Requirements define the minimum “qualifications” that must be associated with a particular group member in order for the group member to utilize the right or fulfill the responsibility.

When talking about responsibilities and the group members who fulfill those responsibilities consider that a list of qualifications is a list of attributes that a group member possesses, which describe the group member's skills or capabilities. For example, a group member might possess the ability to teach 10th grade or the ability to work as a bartender. In this example, “ability to teach 10th grade” and “ability to work as a bartender” are attributes, and these attributes are listed as qualifications that a particular group member possesses. A list of requirements is a list of attributes that a responsibility requires. For example, a responsibility might require the ability to teach 10th grade or the ability to work as a bartender. In this example, “ability to teach 10th grade” and “ability to work as a bartender” are attributes, and these attributes are listed as requirements that a particular responsibility requires.

When talking about rights and the group members who utilize those rights consider that a list of qualifications is a list of attributes that a right possesses, which describe the right's skills or capabilities. For example, a right might possess the ability to perform 6-degree-of-freedom CNC machining or 5-degree-of-freedom milling. In this example, “ability to perform 6-degree-of-freedom CNC machining” and “5-degree-of-freedom milling” are attributes, and these attributes are listed as qualifications that a particular right possesses. A list of requirements is a list of attributes that a group member requires. For example, a group member might require the ability to perform 6-degree-of-freedom CNC machining or the ability to perform 5-degree-of-freedom milling. In this example, “ability to perform 6-degree-of-freedom CNC machining” and “ability to perform 5-degree-of-freedom milling” are attributes, and these attributes are listed as requirements that a particular group member requires.

As an example, an employee exchange scenario will only be successful if the substitute employee offers qualifications that meet or exceed the requirements of the task and the task offers qualifications that meet or exceed the requirements of the substitute employee. Likewise, a facility utilization exchange scenario will only be successful if the facility offers qualifications that meet or exceed the requirements of the substitute facility user and the substitute facility user offers qualifications that meet or exceed the requirements of the facility. As will be described in greater detail, below, the candidate selection criteria 130 is used to list the various criteria, including qualifications and requirements, used by the candidate selection processor 134.

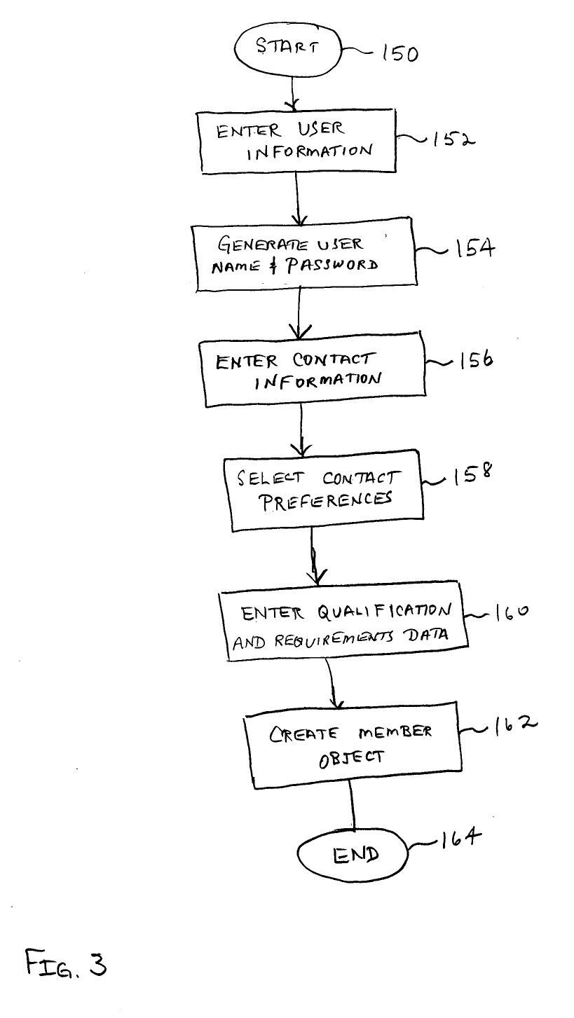

The account creation process is illustrated in the flow chart of FIG. 3 where at a start 150, a group has already been defined. In step 152, the user enters personal information, such as the user's name. In step 154, the user generates a user name and password or a customer number and personal identification number (PIN) number. A user-name and password would typically be used in an implementation where the user utilizes a client computer (e.g., the client computers 110-116 of FIG. 1) to communicate with the server 102. The customer number and PIN may be used in an implementation where the individual utilizes an interactive voice response telephone system to communicate with the server 102 via the telephone interface 108. It should be noted that the user-name and password or customer number and PIN may be generated by the user or generated by the system 100.

In step 156, the user enters contact information. As will be discussed in greater detail below, contact information may comprise, by way of example, mailing address or addresses, telephone number(s), facsimile number(s), cell phone number(s), VolP account(s), numeric pager number(s), two-way pager account(s), email address or addresses, text messaging account(s), instant messaging account(s), and the like. As can be appreciated, the system 100 can utilize a variety of communication channels by which the server 102 can contact the user.

In step 158, the user selects contact preferences. For example, the user may wish to be contacted at a specific email address. If the user is not available at the specific email address, the user may specify an alternative communication form, such as a cell phone number or text messaging account. Thus, selection of contact preferences may detail an entire hierarchy of contact preferences that will be utilized by the server 102. The contact preferences may also include instructions not to contact the user via certain communication channels, to contact the user only during certain hours, or to utilize certain channels only in case of an emergency.

In step 160, the user's qualifications and requirements are entered into the system 100. The qualifications and requirements may be entered by the user or by the administrator. Those skilled in the art will appreciate that the qualifications and requirements will vary from one group to another. For example, in the context of a school or school system, user qualifications may include skill sets offered by individual teachers, such as the ability to teach at certain grade levels or certain subjects, while user requirements may include challenges required by individual teachers, such as the minimum grade level that the teacher wishes to teach. For example, a language teacher that is able to teach French and German would not be an acceptable substitute teacher for a Spanish class. Similarly, a history teacher may be an unacceptable substitute for a shop teacher. However, the shop teacher may be qualified to substitute as a history teacher. Further, a teacher who is only willing to teach Calculus would not be a suitable substitute for an Algebra teacher. Sample user qualifications and requirements charts for a school or school system are shown below in Table 1a and 1b.

TABLE 1a
User Qualifications

```
Able to teach Kindergarten
    AM Kindergarten
    PM Kindergarten
Able to teach 1^{st} Grade
Able to teach 2^{nd} Grade
Able to teach 3^{rd} Grade
Able to teach 4^{th} Grade
Able to teach 5^{th} Grade
Able to teach 6^{th} Grade
Able to teach 7^{th t} Grade
Able to teach 8^{th} Grade
Able to teach 9^{th} Grade
Able to teach 10^{th} Grade
Able to teach 11^{th} Grade
Able to teach 12^{th} Grade
Able to teach General Math
Able to teach Algebra
Able to teach Geometry
Able to teach Calculus
Able to teach General Science
Able to teach Chemistry
Able to teach Physics
```

TABLE 1b
User Requirements

30 students or fewer per class
Laboratory classes only
Theoretical classes only
Science classes only
Math classes only
AM classes only
Willing to teach 1^{st} Grade
Willing to teach 2^{nd} Grade
Willing to teach 3^{rd} Grade
Willing to teach 4^{th} Grade
Willing to teach 5^{th} Grade
Willing to teach 6^{th} Grade
Willing to teach 7^{th t} Grade
Willing to teach 8^{th} Grade
Willing to teach 9^{th} Grade
Willing to teach 10^{th} Grade
Willing to teach 11^{th} Grade
Willing to teach 12^{th} Grade
Willing to teach General Math
Willing to teach Algebra
Willing to teach Geometry
Willing to teach Calculus
Willing to teach General Science
Willing to teach Chemistry
Willing to teach Physics

It can be appreciated that the qualifications and requirements listed in Tables 1a and 1b are merely a partial list of possible attributes used in a school or school system. Other attributes could be used by the school. For other groups, the list of attributes would vary. And the present invention is not limited by the specific attributes used to describe a group member.

In step 162, the system 100 creates a member object or record that associates the various pieces of information entered by the user and/or administrator. The process of new member creation ends at step 164. Thus, a new member has been associated with the group and the qualifications and requirements of the new member have been defined. If the new member is the first member of a group, a group name or other identification may also be provided to the system 100. As new group members are added, that same group identification is utilized. In the example above, a single group may be created for a school. However, those skilled in the art will appreciate that one or more groups may be defined for a single school or, in an alternative implementation, individual schools within a school system may be groups while the school system as a whole is yet another group. Individuals may be members of one or more groups. In addition, the system 100 can be configured to use a predetermined hierarchy in determining the suitable candidate pool 132 (see FIG. 2). In the example of multiple schools within a school system, it may be preferable to select a substitute or exchange among teachers of the same school. If a substitute or exchange teacher is not available from within that school, then the search by the candidate selection processor 134 may be expanded to include other schools within the school system group. Thus, the system 100 offers great flexibility in the definition of groups and group members.

A system administrator may be designated to have authority to create groups and additional supervisors and/or administrators may be designated for each group. Those group administrators have the authority to add, delete, or edit the entries for group members, including qualifications, requirements, contact information and the like, as well as the authority to assign group members to and remove group members from rights and responsibilities. Group administrators may also be granted the authority to create subgroups. In the example above of a school system being designated as a single group, administrators for each school may be designated as the supervisor/administrator for their respective school subgroup.

Conventional security systems may be employed to prevent unauthorized access of data. For example, individual group members may be prohibited from accessing any group member data, including their own. However, a group member may also be given authority to view his or her own data. In yet another alternative embodiment, a group member may have authority to edit his or her own data. This right may be limited to certain data, such as contact information, while prohibiting alteration of other group member attributes. In yet another alternative embodiment, the administrator may be assigned various authorization levels to view selected group member data, edit selected group member data, or the like. Such access authorization is known in the art and need not be described in greater detail herein. Thus, the system 100 offers reliable security to prevent unauthorized access of data.

After a group has been defined, members have been added to the group, and qualifications and requirements have been associated with the group members, group administrators must then define a set of rights offered by the group and/or a set of responsibilities demanded by the group, assign qualifications and requirements to those rights and responsibilities, and optionally assign those rights and responsibilities to individual group members. As detailed above, the term “rights” refers to any role or service that a group controls and allows group members to utilize. For example, a group may control a particular testing facility and may offer group members rights to utilize that facility at certain dates and times. In such a situation, permission to utilize the facility on a certain date during a certain time period would be a right that can be assigned to an individual group member. As also detailed above, the term “responsibilities” refers to any role or service that a group demands and expects group members to fulfill. For example, a group may demand that a set of work shifts be covered by group members and may therefore assign group members the responsibility of fulfilling particular shifts. In such a situation, a certain work shift on a certain date spanning a certain time period would be a responsibility that can be assigned to an individual group member. Qualifications and requirements must be assigned to a group's rights and responsibilities so that group members, who are also associated with qualifications and requirements, can be properly assigned to the group's rights and responsibilities. As an example, an employee exchange scenario will only be successful if the substitute employee (i.e., the group member) offers qualifications that meet or exceed the requirements of the task (i.e., the responsibility) and the task (i.e., the responsibility) offers qualifications that meet or exceed the requirements of the substitute employee (i.e., the group member). Likewise, a facility utilization exchange scenario will only be successful if the facility (i.e., the right) offers qualifications that meet or exceed the requirements of the substitute facility user (i.e., the group member) and the substitute facility user (i.e., the group member) offers qualifications that meet or exceed the requirements of the facility (i.e., the right).

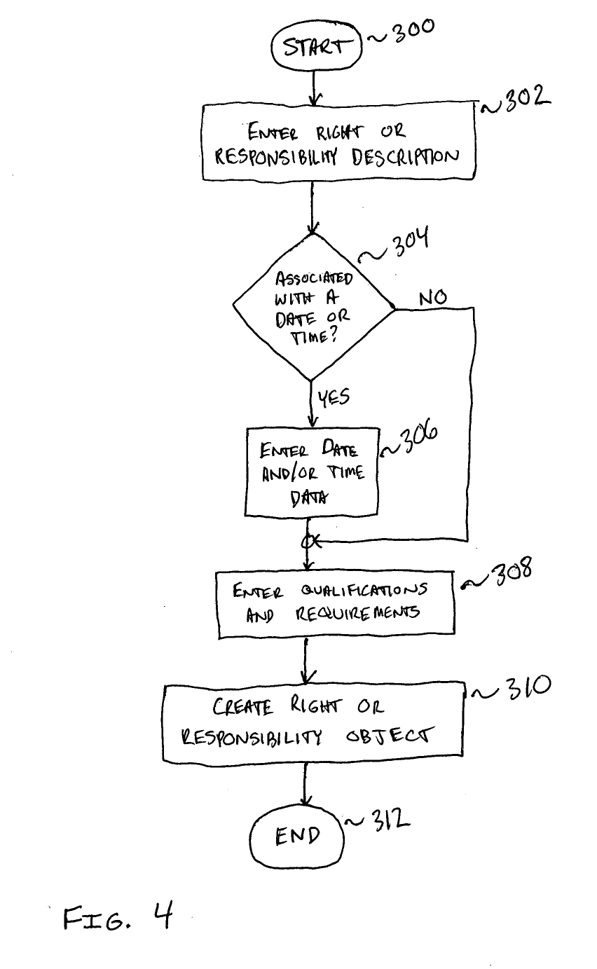

The right and responsibility creation process is illustrated in the flow chart of FIG. 4 where at a start 300, a group has already been defined. In step 302, the user enters into the system 100 a description of the right or responsibility, such as the name, classification, category, or sub-category of the right or responsibility. In decision 304, the user determines if the right or responsibility is associated with a date or time. While rights and responsibilities such as the utilization of facilities and services or the fulfillment of work shifts or services will typically be associated with a date and time, other rights and responsibilities, such as a group member's position within an organization or a task assigned to a group member, may not be associated with a date or time. If the particular right or responsibility is not associated with a date or time, the result of decision 304 is NO and the user advances to step 308. If the particular right or responsibility is associated with a date or time, the result of decision 304 is YES and the user advances to step 306, where the user enters into the system 100 the date and/or time associated with the right or responsibility.

In step 308, the rights or responsibility's qualifications and requirements are entered into the system 100. The qualifications and requirements may be entered by the user or by the administrator. Those skilled in the art will appreciate that the qualifications and requirements will vary from one group to another. For example, in the context of a restaurant or restaurant chain, responsibility requirements may include skill sets required by individual shifts or positions, such as a knowledge of food, a knowledge of wine, the ability to speak French, the ability to serve as a host or hostess, the ability to receive customer phone calls, or the ability to serve as a waiter or waitress. As a further example, in the context of an automotive testing facility, right qualifications may include capabilities offered by individual laboratories within the facility, such as high speed photography, barrier crash testing, hot weather and cold weather simulation chambers, and accelerated corrosion environments. Therefore, in the context of a restaurant or restaurant chain, a shift requiring an ability to serve as a waiter or waitress could not be fulfilled by an employee qualified only to clear tables. Similarly, a position requiring wine expertise could not be fulfilled by an employee with only food knowledge. Further, a testing laboratory offering only low-speed photography and barrier crash testing could not be utilized by a group member requiring high-speed photography and barrier crash testing. Likewise, a shift offering only sommelier experience would not be fulfilled by an employee willing to take on only management level positions. Sample right and responsibility qualifications and requirements charts for a restaurant or restaurant chain are shown below in Tables 2a and 2b.

TABLE 2a
Right and Responsibility Qualifications

Offers manager training credits
Management level position
Offers no management responsibilities
Provides customer interaction
Offers no customer interaction
Can be utilized or fulfilled by handicapped individuals

TABLE 2b
Right and Responsibility Requirements

Knowledge of food
Knowledge of wine
Ability to speak English
Ability to speak Spanish
Ability to speak French
Host or hostess training
Ability to handle customer phone calls
Ability to serve as waiter or waitress
Chef Training
Chef Assistant Training
Ability to manage staff
Must communicate well with customers

It can be appreciated that the qualifications and requirements listed in Tables 2a and 2b are merely a partial list of possible attributes used in a restaurant or restaurant chain. Other attributes could be used by the restaurant. For other groups, the list of attributes would vary. And the present invention is not limited by the specific attributes used to describe a right or responsibility.

In step 310, the system 100 creates a right or responsibility object or record that associates the various pieces of information entered by the user and/or administrator. The process of right or responsibility creation ends at step 312. Thus, a new right or responsibility has been associated with the group and the qualifications and requirements of the new right or responsibility have been defined. In the example above, a single right or responsibility may be created for a restaurant or restaurant chain. However, those skilled in the art will appreciate that one or more rights or responsibilities may be defined for a single restaurant or, in an alternative implementation, one or more rights or responsibilities may be defined for a group of restaurants or a restaurant chain. Rights and responsibilities may be associated with one or more groups.

A group administrator may be designated to have authority to create rights and responsibilities, and additional supervisors and/or administrators may be designated for each right or responsibility. Those administrators have the authority to add, delete, or edit the entries for rights and responsibilities, including descriptions, dates, times, qualifications, requirements and the like, as well as the authority to assign group members to and remove group members from rights and responsibilities. Administrators may also be granted the authority to create sub-rights or sub-responsibilities. In the example above of an entire day's schedule being designated as a single responsibility, supervisors/administrators for each shift during that day may be designated as the administrators for their respective shift (i.e., sub-responsibility).

Conventional security systems may be employed to prevent unauthorized access of data. For example, individual group members may be prohibited from accessing any right or responsibility data, including rights or responsibilities that they or other group members created. However, a group member may also be given authority to view rights and responsibilities that he or she created, or may be given authority to view rights and responsibilities created by other group members. In yet another alternative embodiment, a group member may have authority to edit rights and responsibilities that he or she created, or may have authority to edit rights and responsibilities created by ether group members. This right may be limited to certain data, such as name or description, while prohibiting alteration of ether right or responsibility attributes. In yet another alternative embodiment, the administrator may be assigned various authorization levels to view selected right or responsibility data, edit selected right or responsibility data, or the like. Such access authorization is known in the art and need not be described in greater detail herein. Thus, the system 100 offers reliable security to prevent unauthorized access of data.

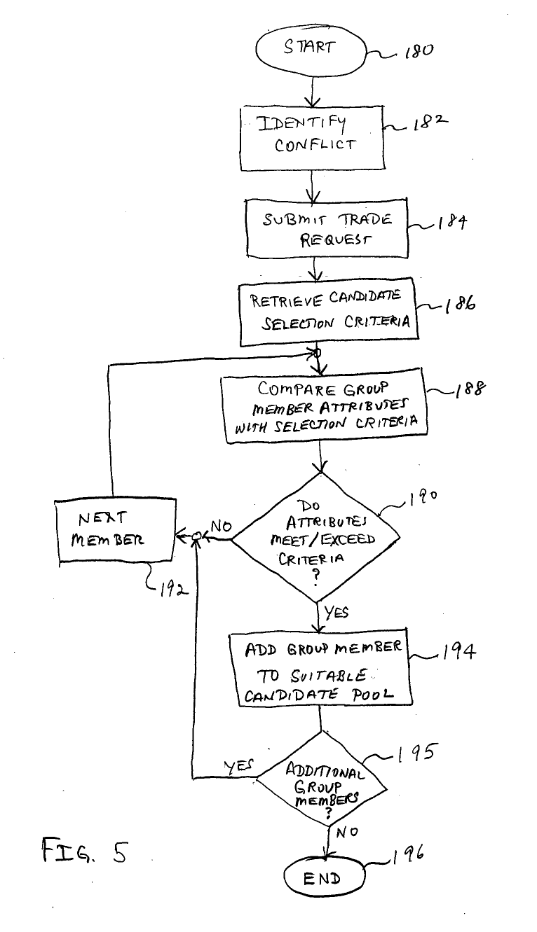

The operation of the system 100 to identify candidates for exchange of rights and responsibilities is illustrated in the flow chart at FIG. 5 where at a start 180, a group, individual group members, rights and/or responsibilities, and, optionally, qualifications and requirements for the group members, rights, and responsibilities have been previously defined. In step 182, a group member (i.e., the originating group member) identifies a conflict. As noted above, the conflict may be, by way of example, a work schedule conflict (i.e., an inability of the group member to fulfill a responsibility) or the inability to utilize a facility, sporting event, or the like (i.e., an inability of the group member to utilize a right).

In step 184, the originating group m ember submits a trade request to the candidate selection processor 134 (see FIG. 2). The trade,request may be submitted through a variety of key indication channels, such as those listed above. The system 100 may conveniently provide a plurality of application program interfaces (APIs) to permit communication via existing hardware or software facilities. For example, the user may utilize Microsoft® Outlook®. An API may be provided that allows communication between the system 100 and Microsoft® Outlook®.

In step 186, the candidate selection processor 134 retrieves the candidate selection criteria 130 (see FIG. 2). As noted above, candidate selection criteria may be related to the qualifications and requirements of the group member requesting the exchange (i.e., the originating group member), the substitute candidates, and the rights or responsibilities that could be exchanged between the group member requesting the exchange and the substitute candidates. In addition to qualifications and requirements, such as job qualifications and required skill levels, the group or employer may also have certain restrictions or criteria that must be applied to select a suitable candidate pool. For example, the employer may require that no overtime result from an exchange of rights or responsibilities. Other employer restrictions may also be applied. For example, the employer may require that any exchange of rights or responsibilities not result in an employee (i.e., a group member) working two shifts in a row. Such restrictions may be important in a setting such as a hospital where extended hours may result in a decrease in efficiency or attentiveness. As another example, a group or employer can specify that group members or employees may or may not be assigned to multiple concurrent rights or responsibilities, or to mutually exclusive or mutually inclusive rights or responsibilities, based upon criteria such as the group member's or employee's qualifications, requirements, experience, skills, capabilities, needs, or desires, and/or criteria such as the right's or responsibility's qualifications, requirements, complexity, simplicity, or required focus level. It can be appreciated that these examples are merely a partial list of the selection criteria that can be included in the candidate selection criteria 130. Other selection criteria could be included in the candidate selection criteria 130 and utilized by the candidate selection processor 134.

In step 188, the candidate selection processor 134 compares the group member attributes with the selection criteria in the candidate selection criteria 130. In decision 190, the candidate selection processor determines whether the attributes of a particular group member meet or exceed the candidate selection criteria. If the attributes of a particular group member do not meet or exceed the established criteria in the candidate selection criteria 130 for this particular trade request, the result of decision 190 is NO and, in step 192, the candidate selection processor 134 moves to the next group member. The process at step 188 is then repeated for the next group member.

If the attributes of a particular group member meet or exceed the established criteria in the candidate selection criteria 130 for this particular trade request, the result of decision 190 is YES. In that event, the candidate selection processor 134 adds that group member to the suitable candidate pool 132. This process is repeated for all group members until the suitable candidate pool 132 is finalized. The process ends at step 196 with a pool of suitable candidates having been identified that meet or exceed the criteria in the candidate selection criteria 130 for this particular trade request.

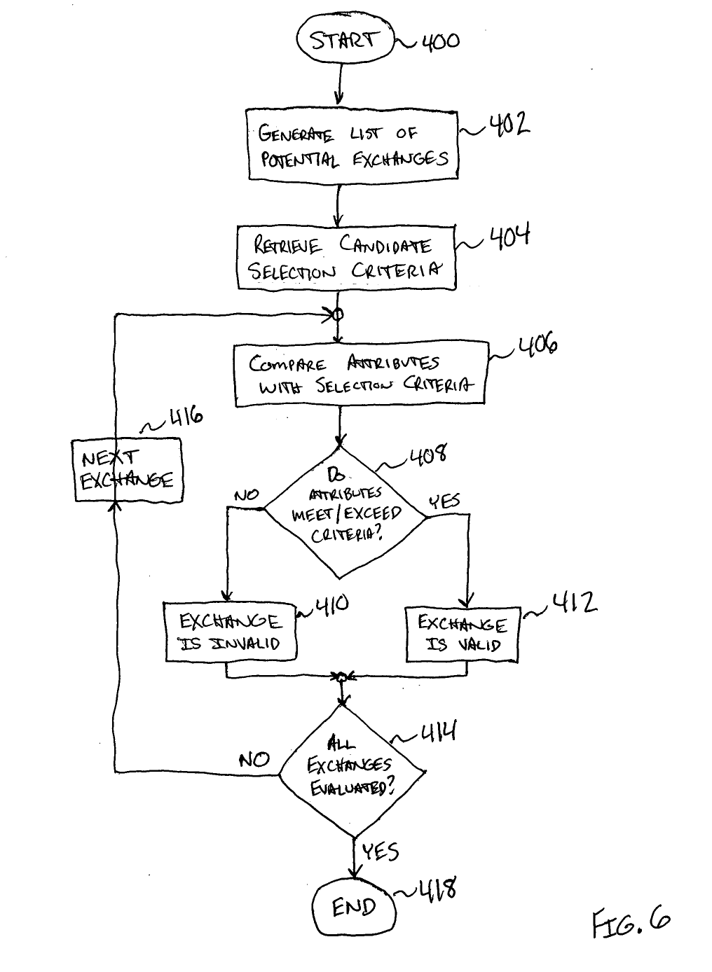

After a suitable candidate pool has been generated, the candidate selection processor 134 must determine what valid exchanges of rights or responsibilities can take place between the group member initiating the trade request (i.e., the originating group member) and the group members in the suitable candidate pool. The process for creating this set of valid exchanges of rights and responsibilities is illustrated in the flow chart of FIG. 6 where at a start 400, a suitable candidate pool 132 for the particular trade request has been identified by the candidate selection processor 134.

In step 402, the candidate selection processor 134 generates a list of all potential exchanges of rights and responsibilities between the originating group member and the group members in the suitable candidate pool. These potential exchanges represent an exhaustive list of all possible exchanges of rights and responsibilities between the originating group member, who is attempting to locate a replacement for one or more of his or her rights or responsibilities, and the members in the suitable candidate pool 132, who could potentially be willing to take over one or more of the originating group member's rights or responsibilities and who could potentially want to exchange one or more of their own rights or responsibilities in return for taking over one or more of the originating group member's rights or responsibilities.

In step 404, the candidate selection processor 134 retrieves the candidate selection criteria 130 (see FIG. 2). These candidate selection criteria may be related to the qualifications and requirements of the originating group member, the group members in the suitable candidate pool 132, and/or the rights or responsibilities that could potentially be exchanged between these group members.

As detailed above, in addition to qualifications and requirements, such as job qualifications and required skill levels, the group or employer may also have certain restrictions or criteria that must be applied to select a set of valid exchanges of rights or responsibilities between the originating group member and the group members in the suitable candidate pool 132. For example, as detailed above, an employer may require that no overtime result from an exchange of rights or responsibilities, or that any exchange of rights or responsibilities not result in an employee (i.e., a group member) working two shifts in a row.

As also detailed above, a group or employer can specify that group members or employees may or may not be assigned to multiple concurrent rights or responsibilities, or to mutually exclusive or mutually inclusive rights or responsibilities, based upon criteria such as the group member's or employee's qualifications, requirements, experience, skills, capabilities, needs, or desires, and/or criteria such as the right's or responsibility's qualifications, requirements, complexity, simplicity, or required focus level. As detailed above, it can be appreciated that these examples are merely a partial list of the selection criteria that can be included in the candidate selection criteria 130. Other selection criteria could be included in the candidate selection criteria 130 and utilized by the candidate selection processor 134.

In step 406, the candidate selection processor 134 selects one potential exchange and compares the attributes of the group members participating in the potential exchange and the attributes of the rights or responsibilities to be exchanged between these group members with the selection criteria in the candidate selection criteria 130. In decision 408, the candidate selection processor determines whether these group members and rights and/or responsibilities meet or exceed the selection criteria. If the group members participating in the potential exchange or the rights or responsibilities to be exchanged between these group members do not meet or exceed the established criteria in the candidate selection criteria 130, the result of decision 408 is NO and, in step 410, the candidate selection processor 134 classifies the potential exchange as invalid.

If the group members participating in the potential exchange and the rights or responsibilities to be exchanged between these group members do meet or exceed the established criteria in the candidate selection criteria 130, the result of decision 408 is YES and, in step 412, the candidate selection processor 134 classifies the potential exchange as valid.

In decision 414, the candidate selection processor determines if all potential exchanges of rights and responsibilities between group members have been evaluated for validity. If not all potential exchanges of rights and responsibilities between group members have been evaluated for validity, the result of decision 414 is NO and, in step 416, the candidate selection processor advances to the next potential exchange of rights and responsibilities between group members, and the process at step 406 is then repeated for the next potential exchange. If all potential exchanges of rights and responsibilities between group members have been evaluated for validity, the result of decision 414 is YES and the candidate selection processor 134 advances to step 418. The process ends at step 418 with a set of valid exchanges of rights and responsibilities between the originating group member and the group members in the suitable candidate pool 132 having been identified for the particular trade request.

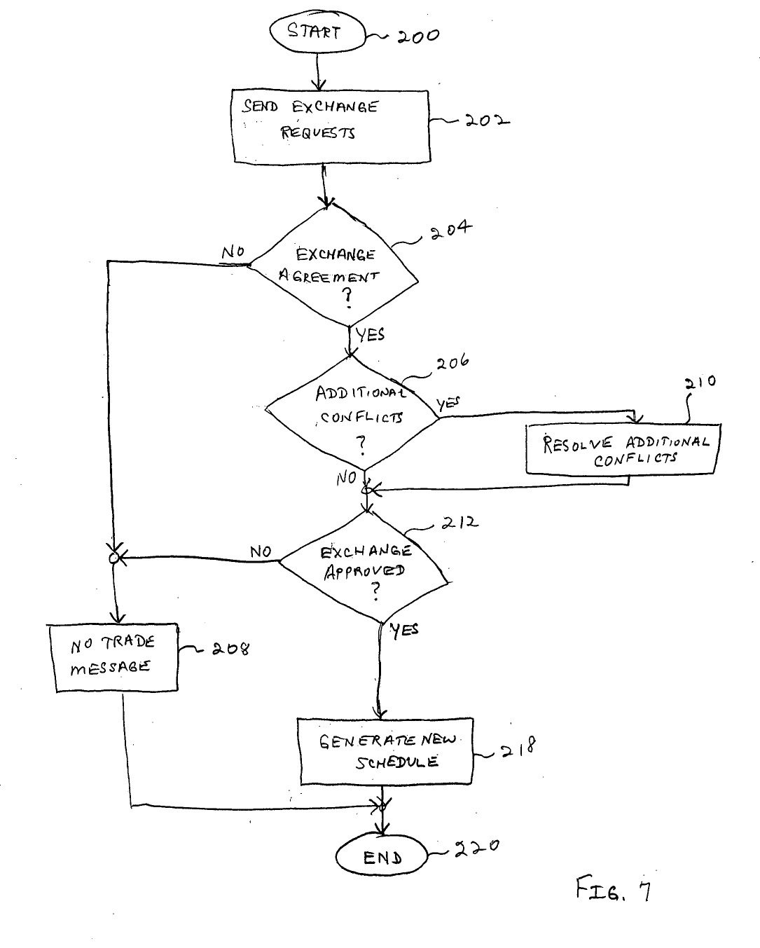

The process for arranging exchanges of rights and responsibilities is illustrated in the flow chart of FIG. 7 where at a start 200, a suitable candidate pool 132 and a set of valid exchanges of rights and responsibilities between the originating group member and the group members in the suitable candidate pool 132 have been identified by the candidate selection processor 134 for the particular trade request.

In step 202, the candidate selection processor 134 sends exchange requests to the originating group member and to the suitable candidate pool members. These exchange requests ask the originating group member and the suitable candidate pool members to commit to one or more of the valid exchanges of rights and responsibilities generated by the process depicted in FIG. 6 and described above. As noted above, the form of communication is selected based on contact preferences provided by the individual group members. Although email communication is a simple and convenient communication technique, the system 100 is capable of communication via email, telephone, facsimile, cell phone communication, voice messaging, voice message over Internet, instant messaging, text messaging, or any ether convenient form of communication. The system 100 provides the necessary APIs to permit the candidate selection processor 134 to send exchange requests via the preferred communication channel. Based on preferences provided by the originating group member and/or group administrators, the candidate selection processor 134 can send exchange requests to only a portion of the suitable candidate pool members, can send exchange requests in ordered batches, or can send individual exchange requests in a particular order. For example, the originating group member may not want all suitable candidate pool members to know that he or she is unable to utilize a particular right or fulfill a particular responsibility, and he or she may therefore opt to specify which of the suitable candidate pool members may initially receive an exchange request from the candidate selection processor 134. In such a situation, it would be possible for the originating group member to specify only close associates as exchange request recipients. The originating group member may additionally specify that exchange requests may be sent to all ether suitable candidate pool members only after no positive response has been received from the first batch of exchange requests. Alternatively, a group administrator may specify that exchange requests are sent to all suitable candidate pool members, but are sent according to ascending or descending order of skill set, experience, qualifications, or requirements, or according to how many or how few hours each suitable candidate pool member has worked or will work during a specified time period.

Members of the suitable candidate pool 132 receive exchange requests and can reply affirmatively or negatively as to their willingness to commit to an exchange. In an exemplary embodiment, time deadlines may be imposed by the originating group member offering the exchange or by the group itself, which may, by way of example, require that any exchanges be completed within a certain time period or in advance, by a predetermined time period, of the date and time associated with the rights or responsibilities being exchanged. If a suitable candidate pool member does not reply within a prescribed time period, the response may be entered into the system 100 as a negative response. In yet another alternative embodiment, an affirmative or negative response may be entered into the system 100 automatically by the candidate selection processor 134 based on preferences provided by individual group members and/or group administrators. For example, a group member may want to always respond affirmatively to exchanges with the group member's supervisor. In such a situation, the group member would define a selection instruction specifying that the candidate selection processor 134 shall always enter an affirmative response on behalf of the group member to exchanges with the group member's supervisor. As an additional example, a group member may want to always respond negatively to exchanges if participating in the exchanges would result in the group member being assigned to 30 or more hours of responsibilities in a single week. In such a situation, the group member would define a selection instruction specifying that the candidate selection processor 134 shall always enter a negative response on behalf of the group member to exchanges if participating in the exchanges would result in the group member being assigned to 30 or more hours of responsibilities in a single week.

The individual group member requesting the exchange also receives exchange requests and can reply affirmatively or negatively as to their willingness to commit to an exchange. The group member requesting the exchange may choose an exchange based on convenience of the requester, or the mutual convenience of the parties. For example, an individual who cannot perform an employment responsibility on Friday may be willing to exchange responsibilities with someone who might normally work on Thursday rather than exchange responsibilities with an individual who would normally work on Saturday. Other personal or business selection factors may be employed to select a particular exchange. In yet another alternative embodiment, an affirmative or negative response may be entered into the system 100 automatically by the candidate selection processor 134 based on preferences provided by individual group members and/or group administrators. For example, an originating group member may, for a particular trade request, want to respond affirmatively to the first exchange received. In such a situation, the originating group member would define a selection instruction specifying that the candidate selection processor 134 shall, for the particular trade request, enter an affirmative response on behalf of the group member to the first exchange received. As an additional example, a group member may want to always respond negatively to exchanges if participating in the exchanges would result in the group member being assigned to a responsibility on a Saturday or Sunday. In such a situation, the group member would define a selection instruction specifying that the candidate selection processor 134 shall always enter a negative response on behalf of the group member to exchanges if participating in the exchanges would result in the group member being assigned to a responsibility on a Saturday or Sunday.

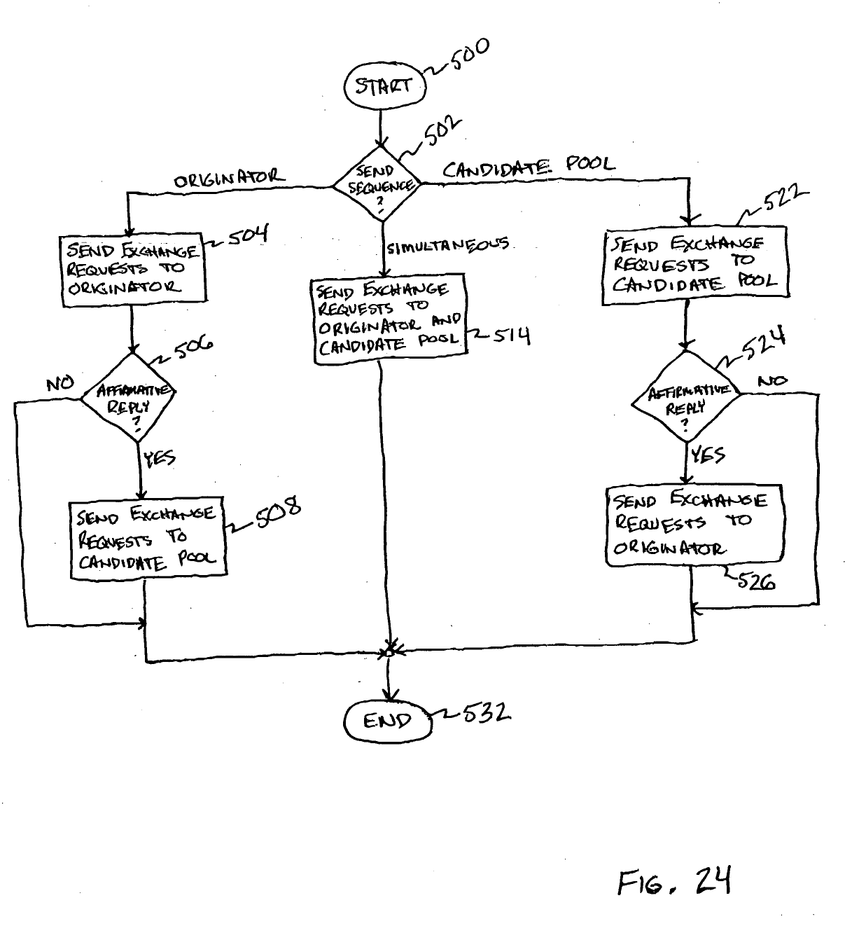

Further details regarding the sending of exchange requests to the originating group member and to the suitable candidate pool members are depicted in the flow chart of FIG. 24, which illustrates the process for determining which exchange requests shall be sent to the originating group member and which shall be sent to the suitable candidate pool members, and in what sequence they should be sent. At a start 500, a suitable candidate pool 132 and a set of valid exchanges of rights and responsibilities between the originating group member and the group members in the suitable candidate pool 132 have been identified by the candidate selection processor 134 for the particular trade request.

In decision 502, the candidate selection processor 134 determines the sequence in which exchange requests should be sent. If exchange requests should first be sent to the originating group member and then to the suitable candidate pool members, the result of decision 502 is ORIGINATOR and the candidate selection processor 134 moves to step 504. Alternatively, if exchange requests should first be sent to the suitable candidate pool members and then to the originating group member, the result of decision 502 is CANDIDATE POOL and the candidate selection processor 134 moves to step 522. Finally, if exchange requests are to be simultaneously sent to both the originating group member and the suitable candidate pool members, the result of decision 502 is SIMULTANEOUS and the candidate selection processor 134 moves to step 514.

The sequence in which exchange requests for a particular trade request should be sent is based on preferences provided by individual group members and/or group administrators. For example, an originating group member may, for a particular trade request, want exchange requests to be sent first to group members in the suitable candidate pool 132 and then to the originating group member. Such an arrangement minimizes the burden on the originating group member, insuring that the originating group member only receives exchange requests for exchanges to which members of the suitable candidate pool 132 have already responded affirmatively. In such a situation, the originating group member would specify a send sequence of CANDIDATE POOL when submitting the trade request to the candidate selection processor 134. As an additional example, an originating group member may, for a particular trade request, want exchange requests to be sent first to the originating group member and then to the group members in the suitable candidate pool 132. Such an arrangement would allow the originating group member to review all exchange requests and respond affirmatively to only those exchanges that are most favorable to the originating group member. Exchange requests for only those exchanges affirmed by the originating group member would then be sent by the candidate selection processor 134 to group members in the suitable candidate pool 132. In such a situation, the originating group member would specify a send sequence of ORIGINATOR when submitting a trade request to the candidate selection processor 134. As a final example, a group administrator may want exchange requests to always be sent simultaneously to both the originating group member and the group members in the suitable candidate pool 132. Such an arrangement would enable exchange requests to be reviewed by all involved parties in a minimum amount of time, as the originating group member and the group members in the suitable candidate pool would receive exchange requests at the same time. In such a situation, the group administrator would specify a group preference that all trade requests have a send sequence of SIMULTANEOUS.

In step 504, the candidate selection processor 134 sends exchange requests to the originating group member. Upon receipt of responses from the originating group member regarding the originating group member's willingness to commit to particular exchanges, the candidate selection processor moves to decision 506 to determine which exchanges have received an affirmative response from the originating group member. For those exchanges that have received an affirmative response from the originating group member, the result of decision 506 is YES and, in step 508, the candidate selection processor 134 sends exchange requests to group members in the suitable candidate pool 132. For those exchanges that have received a negative response from the originating group member, the result of decision 506 is NO and the candidate selection processor 134 moves to step 532 without sending an exchange request to certain candidate pool members because the originating group member did not find one or more possible exchanges satisfactory. In some circumstances, the originating group member may find no satisfactory exchanges and the process ends at 532 with no exchange requests sent to any candidate pool member. If the result of decision 506 is YES with respect to any of the possible exchanges, the process ends at step 532 with exchange requests having been sent to the originating group member and exchange requests corresponding to exchanges that have received an affirmative response from the originating group member having been sent to group members in the suitable candidate pool 132.

In step 514, the candidate selection processor 134 sends exchange requests simultaneously to both the originating group member and to group members in the suitable candidate pool 132. The candidate selection processor then moves to step 532. The process ends at step 532 with exchange requests having been sent to both the originating group member and to group members in the suitable candidate pool 132.

In step 522, the candidate selection processor 134 sends exchange requests to group members in the suitable candidate pool 132. Upon receipt of responses from group members in the suitable candidate pool regarding their willingness to commit to particular exchanges, the candidate selection processor 134 moves to decision 524 to determine which exchanges have received an affirmative response from all involved group members in the suitable candidate pool. For those exchanges that have received an affirmative response from all involved group members in the suitable candidate pool, the result of decision 524 is YES and, in step 526, the candidate selection processor 134 sends exchange requests to the originating group member. For those exchanges that have received a negative response from one or more involved group members in the suitable candidate pool, the result of decision 524 is NO and the candidate selection processor 134 moves to step 532 without sending an exchange request to the originating group member for those particular ones of the possible exchanges. In some circumstances, none of the possible exchanges may be acceptable to the candidate pool members and the process ends at 532 without sending any exchange request to the originating group member. If one or more of the possible exchanges are acceptable to the candidate pool members, the process ends at step 532 with exchange requests having been sent to group members in the suitable candidate pool 132 and exchange requests corresponding to exchanges that have received an affirmative response from all involved group members in the suitable candidate pool having been sent to the originating group member.

Upon completion of the process at step 532, control is returned to the process for arranging exchanges of rights and responsibilities as illustrated in the flow chart of FIG. 7. In decision 204 the candidate selection processor 134 determines whether there is an exchange agreement. An exchange agreement occurs when the originating group member and all group members in the suitable candidate pool involved in a particular exchange have replied affirmatively as to their willingness to commit to the exchange. If the originating group member or one or more group members in the suitable candidate pool involved in a particular exchange fail to reply affirmatively as to their willingness to commit to the exchange, the result of decision 204 is NO and a no trade message may be transmitted to the group member requesting the exchange at step 208.

If the originating group member and all group members in the suitable candidate pool involved in a particular exchange have replied affirmatively as to their willingness to commit to the exchange, an exchange agreement is reached, the result of decision 204 is YES, and the candidate selection processor 134 moves to decision 206 to determine if additional conflicts exist. If no additional conflicts exist, the result of decision 206 is NO and, in decision 212, the proposed exchange is submitted for approval.

If additional conflicts do exist, the result of decision 206 is YES and, in step 210, the system 100 resolves the additional conflicts. The description thus far has focused on a simple exchange between two group members. However, the system 100 is not limited to such a simple exchange. The principles of the present invention may be extended in an unlimited fashion to permit N-way exchanges to take place. For example, there may be a situation in which a group member A requests an exchange of rights or responsibilities. Group member B agrees to take over a right or responsibility from group member A, but this exchange means that group member B must exchange some ether right or responsibility in order to accommodate the first exchange. In exchange, group member A agrees to take over a right or responsibility from group member C while group member C agrees to take over a right or responsibility from group member D and, in turn, group member D agrees to take over a right or responsibility from group member B. In this multi-member exchange, the system 100 resolved a number of conflicts and allowed a complex exchange of responsibilities. The execution of step 210 may require multiple executions of the procedure described with respect to the flow charts of FIGS. 5-7 and 24. In the four-way exchange example provided above, the willingness of group member B to take over a right or responsibility from group member A created a separate conflict for group member B. That conflict was resolved by group member D agreeing to take over the right or responsibility from group member B. In turn, however, there was an additional conflict for group member D. This conflict was resolved by group member C agreeing to take over the right or responsibility from group member D, but raised an additional conflict for group member C. This conflict was resolved by group member A agreeing to take over the right or responsibility from group member C. Each of these additional conflicts required the identification of a conflict, a request for an exchange, identification of a suitable candidate pool, creation of a set of valid exchanges, and communication of exchange requests to group members.

Once conflicts have been resolved or if no additional conflicts exist, the exchange is submitted to a third party for approval in decision 212. Although this is an optional step, it permits one or more supervisors/administrators the opportunity to review and approve the exchange. Administrative approval may take a variety of forms. For example, an administrator may reject a proposed exchange if the exchange requires interaction between group members that the administrator does not want interacting with each ether for some reason. This option permits administrators to determine which employees may or may not work together. Some exchanges may require the approval of ether group members even though the group member is not personally involved in the exchange. In another example, an administrator may reject a proposed exchange if the exchange requires interaction between the group member and certain customers that does not want interacting with each ether for some reason. This option permits administrators to determine which employees may or may not work with which customers. If the exchange is not approved, the result of decision 212 is NO and the system moves to step 208 to transmit a no trade message to the requestor.

If the exchange is approved, the result of decision 212 is YES and the system 100 generates a new schedule at 218 and the process ends at 220 with the exchange of rights and responsibilities between one or more group members.

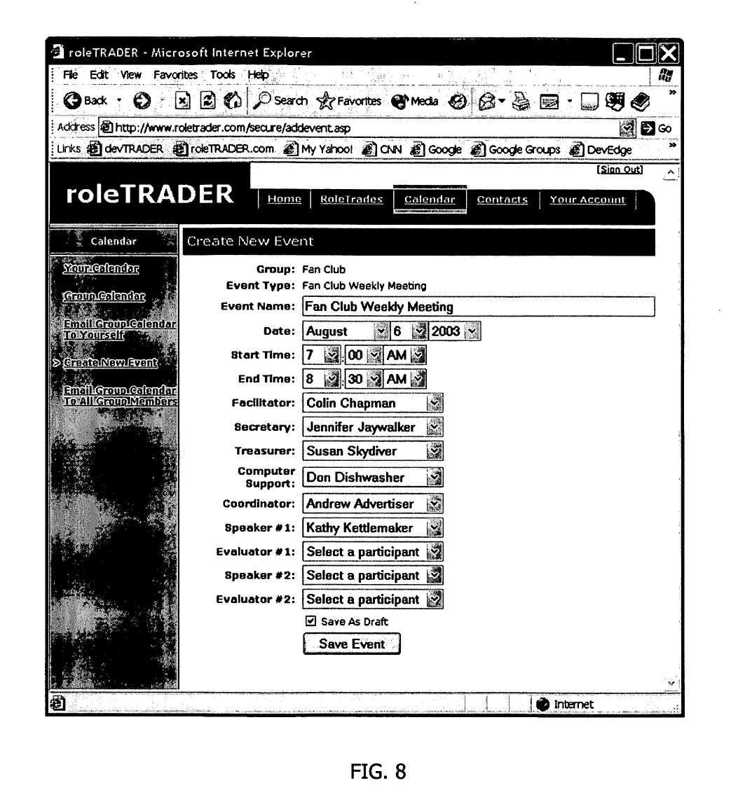

FIGS. 8-23 are screen displays illustrating the operation of the system 100 using a communications channel, such as Microsoft® Internet Explorer® for Internet communication.

FIG. 8 illustrates a screen display used by a system supervisor or administrator of a group to create a new event. At the creation of the new event, rights and responsibilities are assigned to individual group members. It is possible for the system or group administrator to create a number of new events and assign multiple group members to specific rights or responsibilities related to the events.

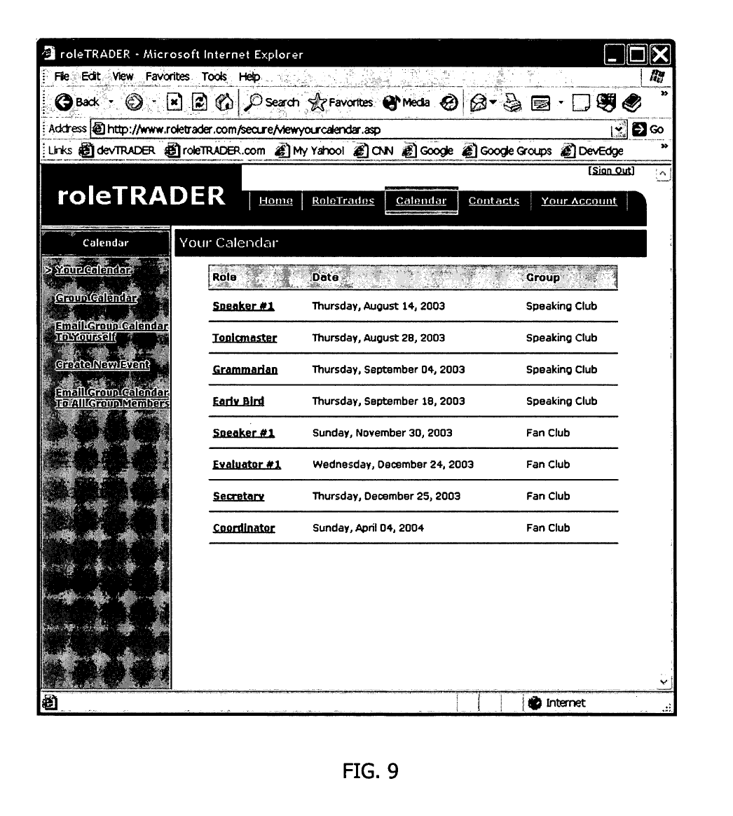

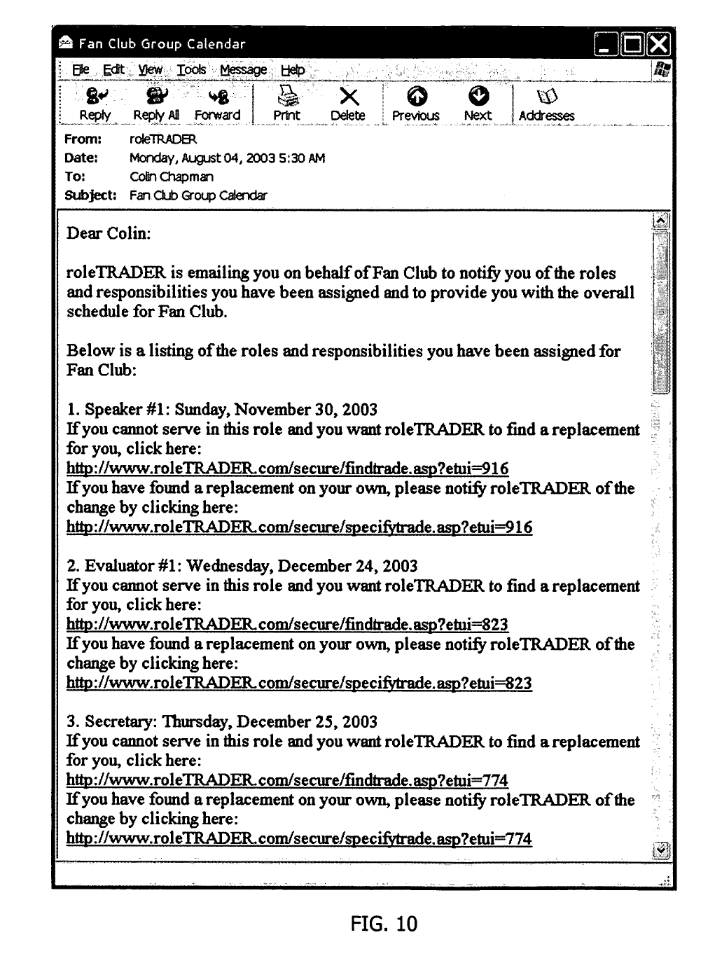

FIG. 9 illustrates an example message sent to a group member listing the upcoming rights and responsibilities assigned to the group member for a plurality of events. FIG. 10 is a sample email sent to an individual group member indicating their upcoming rights and responsibilities. In the example illustrated in FIG. 10, links may be provided for the group member to seek an exchange of rights or responsibilities. The example at FIG. 10 also illustrates the provision of additional links if the group member has already arranged for an exchange of rights or responsibilities.

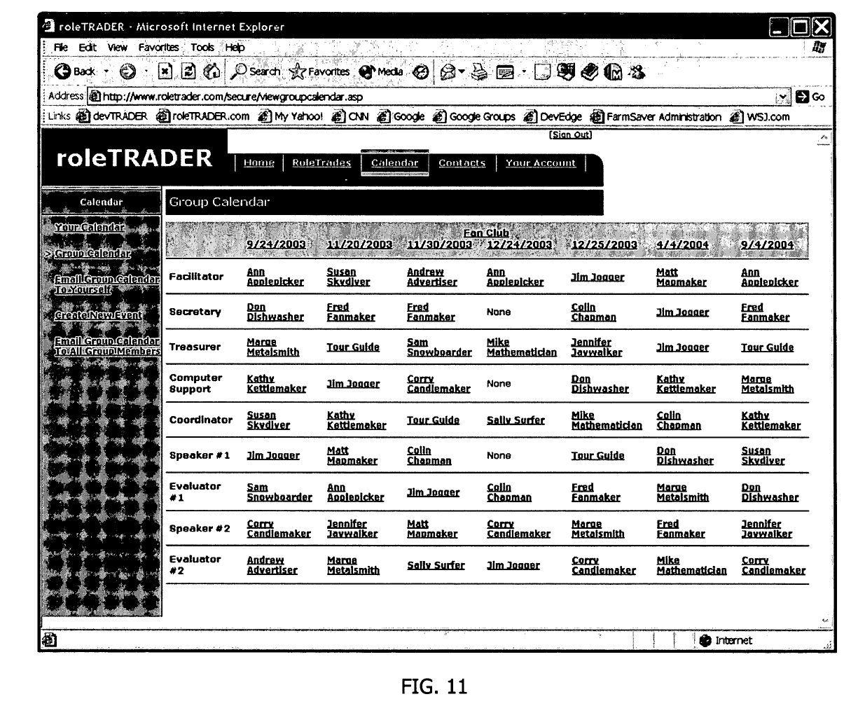

FIG. 11 is a screen display of a number of upcoming events and the various rights and responsibilities assigned to group members for each event. Although not essential to satisfactory operation of the system 100, the group calendar illustrated in FIG. 11 may be conveniently used by a group member to identify possible candidates for the exchange of rights and responsibilities. It should be noted that the identification of possible candidates for the exchange of rights and responsibilities may be performed manually by the user, using scheduling data, such as that illustrated in FIG. 11, or may be done automatically using the candidate selection processor 134 in the manner described above.

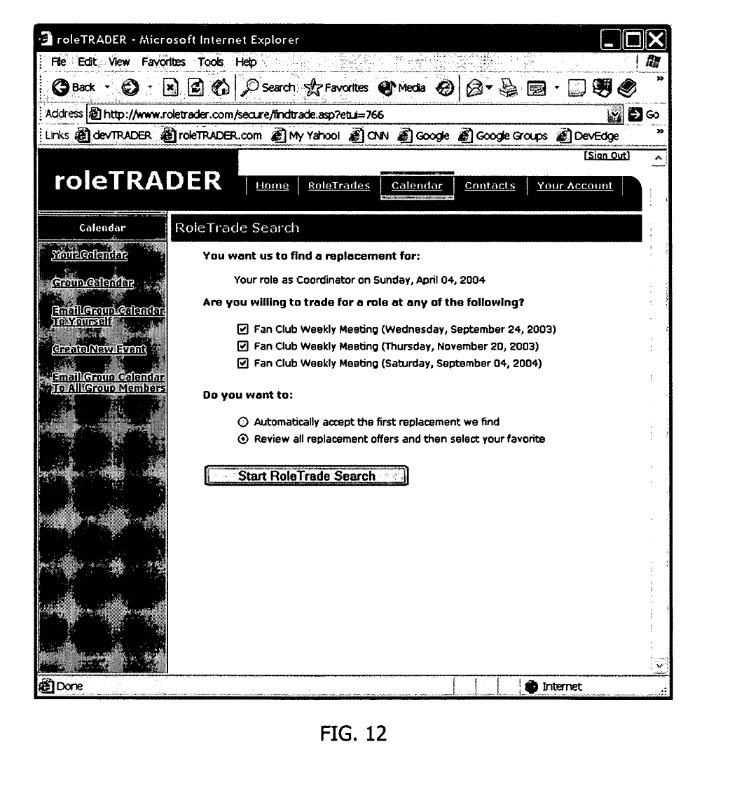

FIG. 12 is a response message sent to a group member requesting an exchange of rights or responsibilities. FIG. 12 indicates the right or responsibility for which an exchange is sought and requests additional information as to ether rights or responsibilities that the requestor is willing to accept in exchange. In addition, the requestor may request that the system 100 automatically implement the first exchange offer received or allow the requestor to review all exchange offers and then select a single, preferred exchange offer based on convenience of the requestor, or the mutual convenience of the parties.

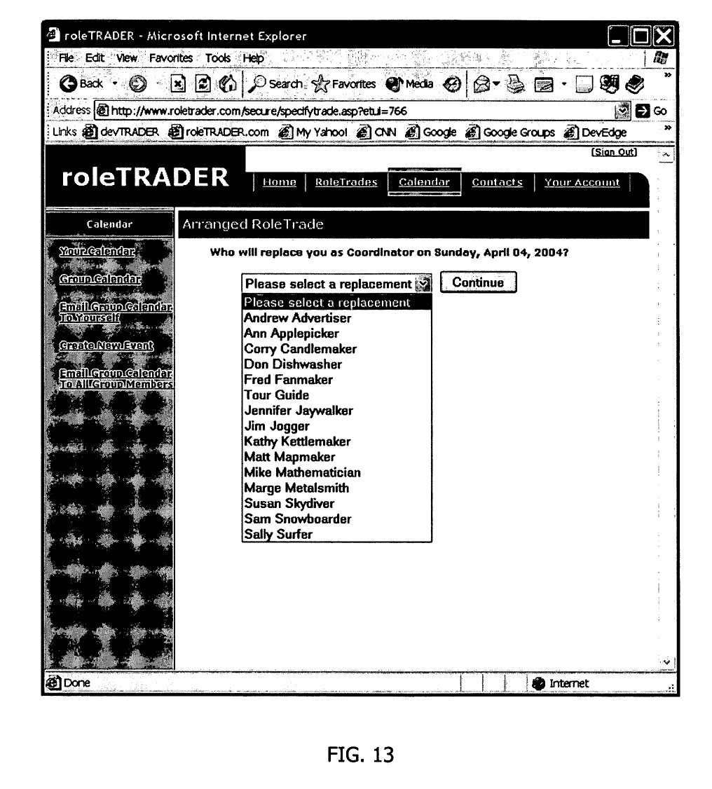

FIG. 13 is a response message sent to a group member who has gone out on their own initiative, located their own replacement, and negotiated an exchange of rights or responsibilities with that replacement (in essence, the group member has performed manually everything that the system 100 can perform automatically). In such situations, the response message shown in FIG. 13 allows the group member to simply notify the system 100 of the manually-located replacement. FIG. 13 indicates the right or responsibility for which a replacement has been manually located and requests that the group member provide the name of the manually-located replacement. The list shown in FIG. 13 may simply be a list of all group members, or may optionally be a list of group members in a suitable candidate pool 132 generated by the candidate selection processor 134 using the requirements and qualifications of the right or responsibility for which a replacement has been manually located.

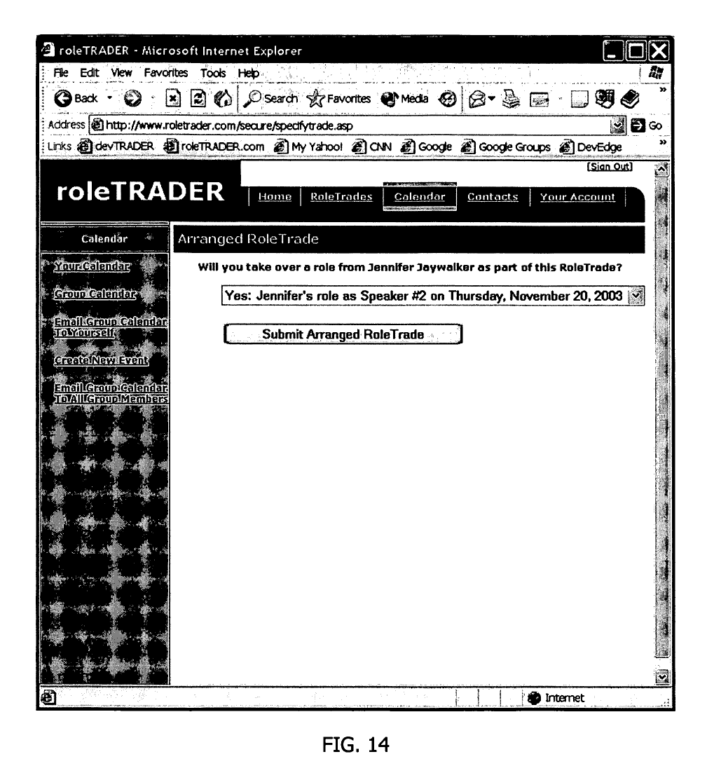

FIG. 14 is a response message sent to a group member who has designated a manually-located replacement using the techniques depicted by FIG. 13 and described above. The response message shown in FIG. 14 allows the group member to notify the system 100 of the details of the manually-negotiated exchange. FIG. 14 indicates the right or responsibility for which a replacement has been manually located as well as the name of the manually-located replacement, and requests that the group member designate if the group member shall take over a right or responsibility from the replacement in return for the replacement taking over the aforementioned right or responsibility from the group member. The list shown in FIG. 14 may simply be a list of all rights and responsibilities currently assigned to the replacement, and therefore potentially available to be exchanged to the group member, or may optionally be a list of rights and responsibilities that the candidate selection processor 134 has verified as valid and available to be exchanged to the group member.

In such situations, where a group member has gone out on their own initiative, located their own replacement, and negotiated an exchange of rights or responsibilities with that replacement, and then simply notifies the system 100 of the exchange using the techniques depicted in FIGS. 13 and 14 and detailed above, the candidate selection processor 134 need not build a list of suitable candidates, a list of valid exchanges, or contact the pool of suitable candidates. However, in these situations the candidate selection processor 134 can verify that the proposed replacement is suitable and that the proposed exchange is valid and then contact the designated replacement to obtain their confirmation of the trade and, if necessary, administration approval.

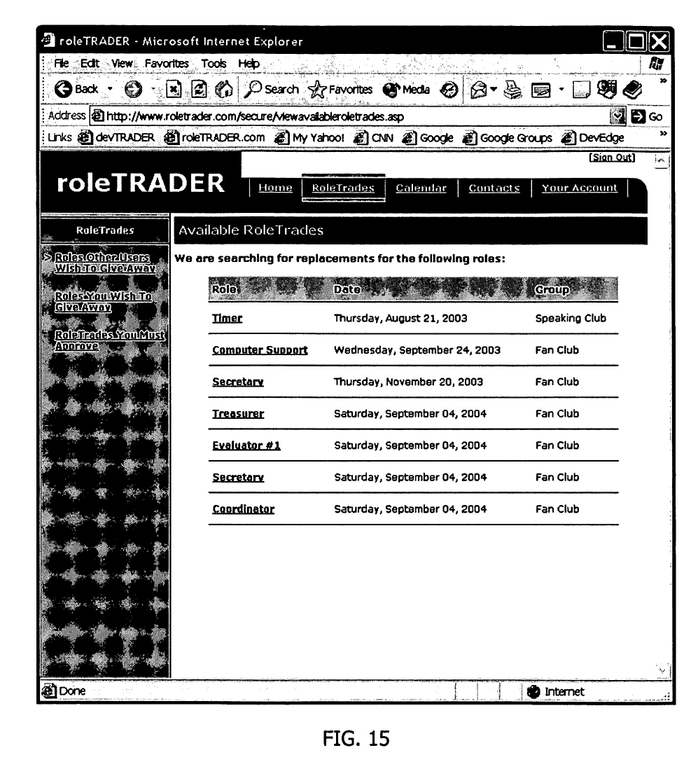

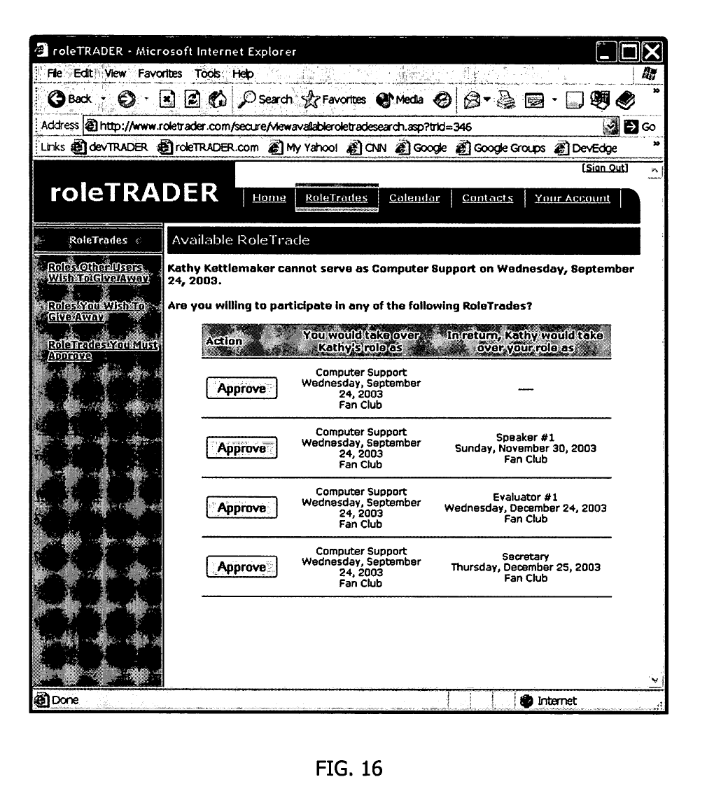

FIG. 15 illustrates a list of rights or responsibilities for which ether group members have requested exchanges. FIG. 16 is a sample display of an exchange request message sent to a member of the suitable candidate pool 132, indicating a request for exchange of rights or responsibilities with another group member. The message indicates the particular right or responsibility for which replacement is being sought and details all possible exchanges of rights or responsibilities between the parties.

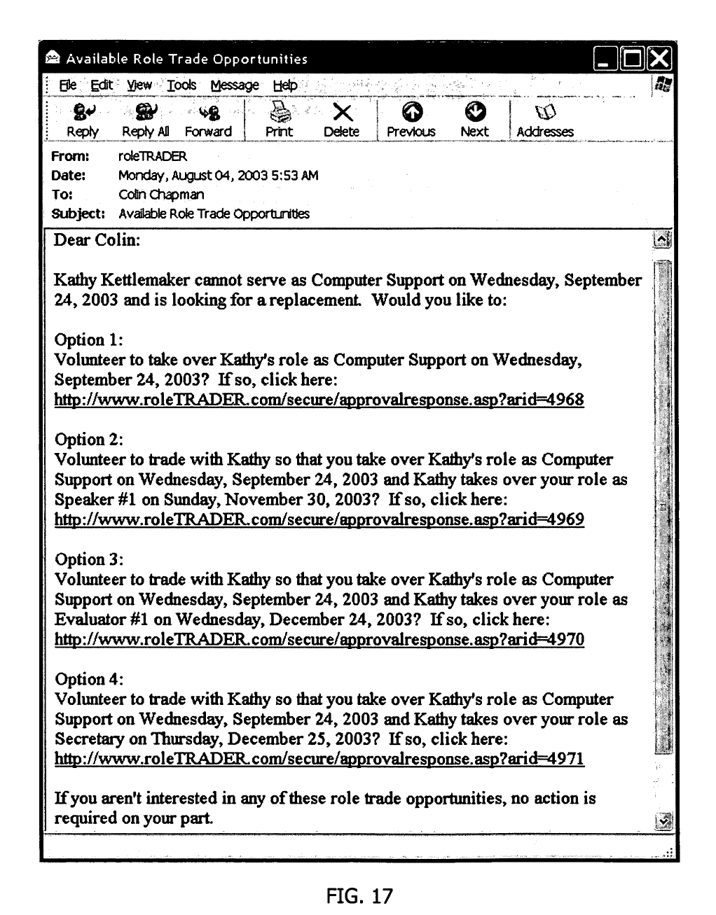

FIG. 17 is an example exchange request message, sent via email to a member of the suitable candidate pool 132, indicating a request for exchange of rights or responsibilities with another group member. The message indicates the particular right or responsibility for which replacement is being sought and details all possible exchanges of rights or responsibilities between the parties. In the example illustrated in FIG. 17, links are provided for each of the exchange possibilities thus simplifying the exchange process. The recipient of the exchange request message can, if willing, accept any one of the four options listed within the request message.

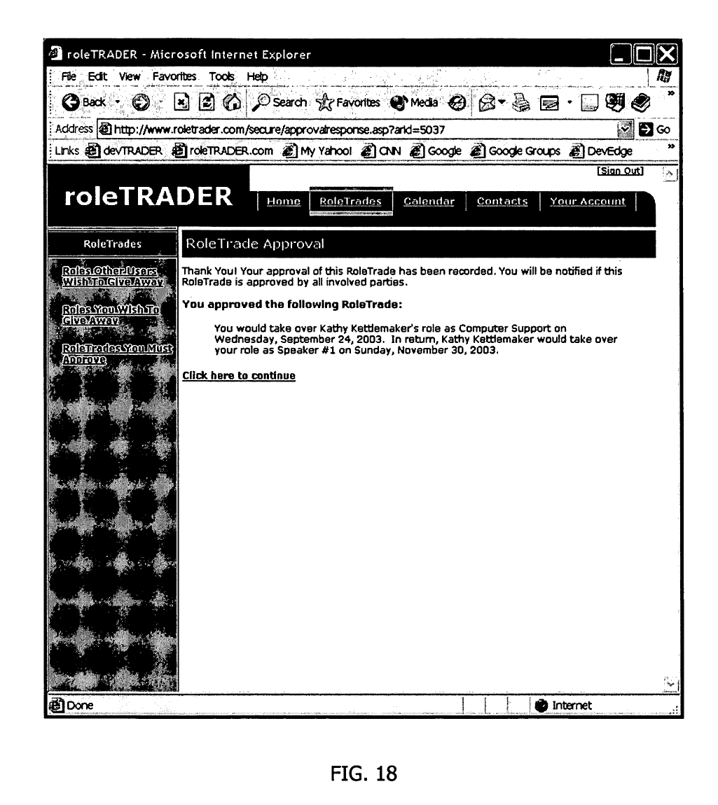

FIG. 18 illustrates a confirmation message automatically generated by the system 100 in response to a group member's confirmation that they are willing to exchange rights or responsibilities with another group member. In an exemplary embodiment, the message, such as that illustrated in FIG. 18, may be generated in response to a confirmation received from a candidate automatically selected by the candidate selection processor 134 (see FIG. 2) or from a replacement manually designated by a group member in the manner depicted in FIGS. 13 and 14 and described above.

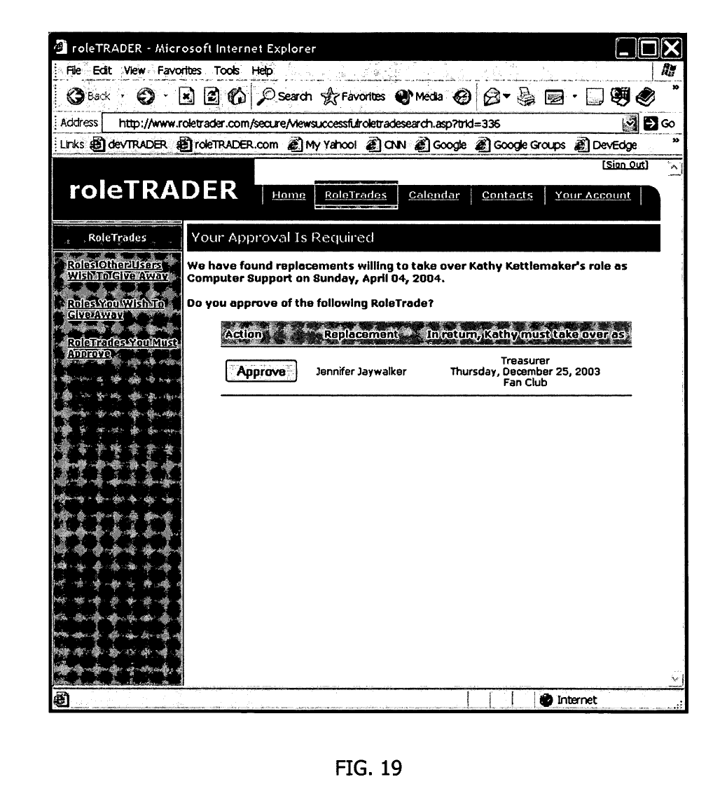

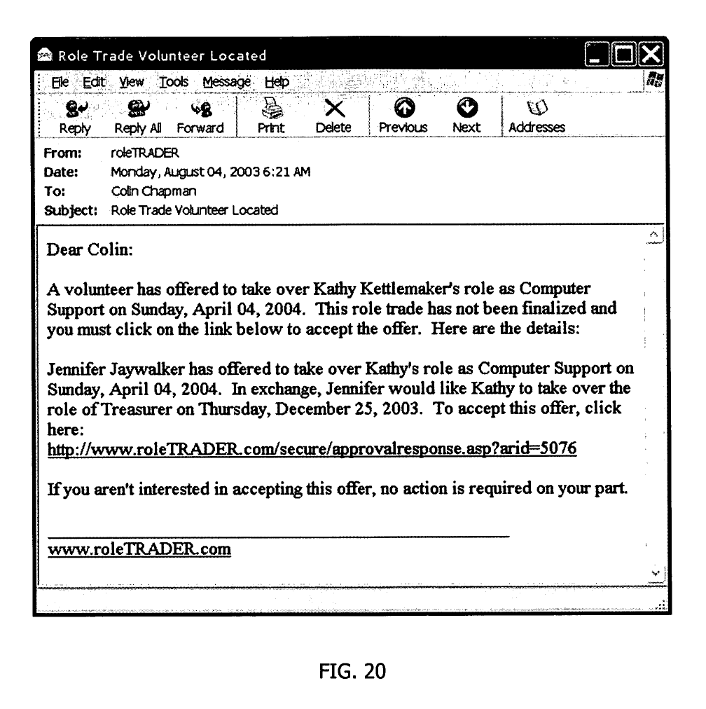

As previously discussed, some exchanges of rights or responsibilities may require approval from one or more supervisors/administrators or ether group members. FIG. 19 illustrates a sample message requesting such authorization or approval of an exchange of rights or responsibilities. FIG. 20 is a sample email message requesting such approval of an exchange of rights or responsibilities.

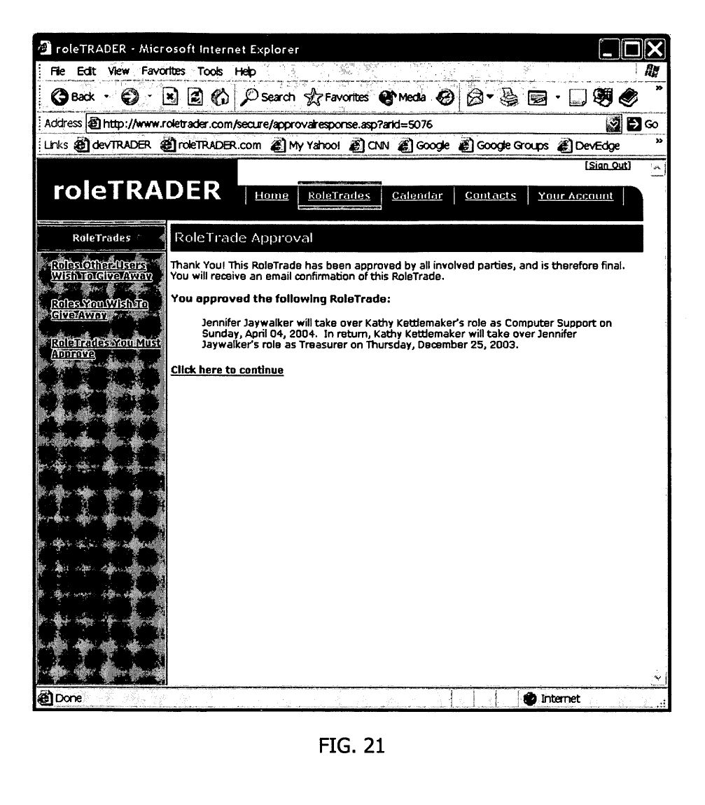

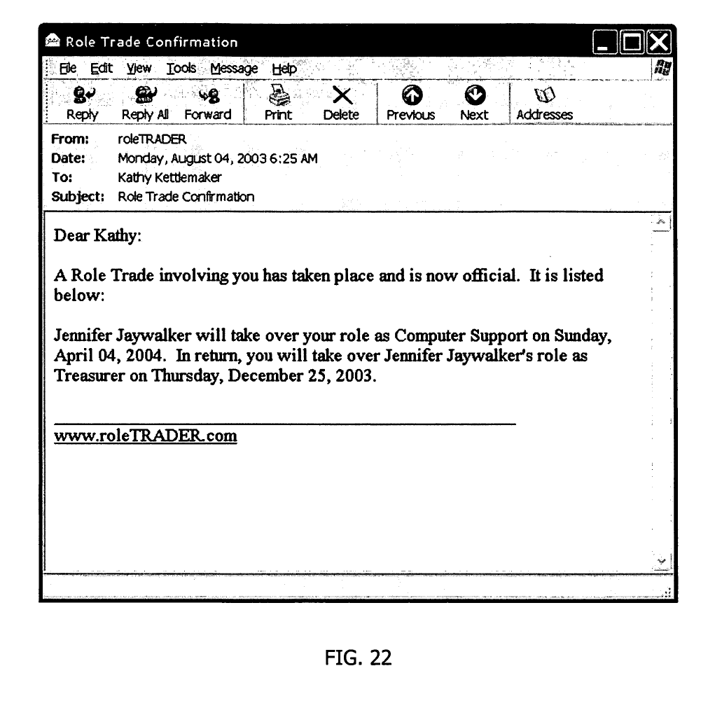

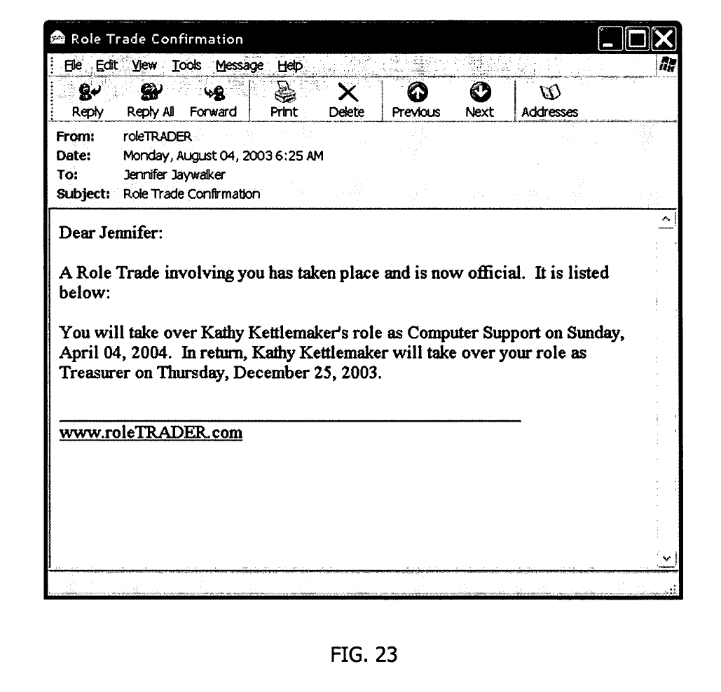

FIG. 21 is a sample display indicating that an exchange of rights or responsibilities has been approved. FIG. 22 is a sample email message to the candidate selected to exchange the rights or responsibilities and confirms that an exchange has occurred. FIG. 23 is a similar email message sent to the original requestor to indicate that an exchange of rights or responsibilities has occurred. Thus, the system 100 provides a simple and convenient technique by which rights and responsibilities can be exchanged among one or more group members. The automated process described herein assures that any exchange of rights and responsibilities will not result in an inappropriate or unacceptable substitution. The system 100 also provides the necessary security to prevent unauthorized access to schedules or access to confidential personal information of group members.

From the foregoing it will be appreciated that, although specific embodiments of the invention have been described herein for purposes of illustration, various modifications may be made without deviating from the spirit and scope of the invention. For instance, the communication link between the system 100 and various group members may be performed telephonically. In this implementation, a telephone call or voice mail message may be left for members of the candidate selection pool 132 (see FIG. 2) providing the necessary information regarding the exchange of rights or responsibilities. To accept an exchange, the user may be required to enter an identification number and/or PIN using the telephone keypad. The user may select an exchange of responsibilities also using the telephone keypad. In one example, where four possible exchanges of rights or responsibilities are offered to the group member, the group member may simply select the number of the desired exchange. These messages may be sent to a conventional telephone using the PSTN (see FIGS. 1-2) or via a wireless network to a cell phone. As another example, the system 100 may communicate with a wireless device, such as a personal digital assistant (PDA), text messaging cell phone, or the like.

The examples presented above describe the exchange of rights and responsibilities between individual members of a group. Those skilled in the art will recognize that the principles of the present invention may be extended to an exchange of rights and responsibilities between individual members of different groups. For example, the faculty of a particular high school may be designated as a group and exchanges occur in the manner described above. The faculty members of a second high school within the same school district may be designated as a separate group for purpose of exchanges. However, the system 100 may be used to process exchanges between individual members of these two groups. Alternatively, the faculty members of all high schools in a particular school district may be considered members of a single group. The designation of groups and group members is a selection feature that may be determined by a system administrator based on the particular application.

Similarly, the system 100 can process exchanges between groups rather than individual group members. For example, a product development team in a large corporation may be designated as a group. The group itself may have rights and responsibilities that can be exchanged with another group within the corporation. Thus, the system 100 is not limited only to exchanges between individuals within a single group.

In yet another alternative embodiment, a group administrator may define a set of rights and/or responsibilities, but not assign those rights and responsibilities to any group members. Rather, the administrator may have the system 100 automatically contact suitable group members asking them to volunteer to utilize the unassigned rights or to fulfill the unassigned responsibilities. The candidate selection processor 134 (see FIG. 2) analyzes the qualifications and requirements of the rights and responsibilities as well as the qualifications and requirements of group members to determine the suitable candidate pool 132, in the manner described above. Communications with suitable candidate pool members can occur in the manner described above such that the system 100 automatically finds candidates to utilize unassigned rights or to fulfill unassigned responsibilities.

In yet another alternative embodiment, the system 100 may query group members that have been assigned to upcoming rights and/or responsibilities to confirm that the group members will utilize the upcoming right or fulfill the upcoming responsibility. This enables the group administrator to feel comfortable that the upcoming rights will be utilized and that the upcoming responsibilities will be fulfilled.

In yet another alternative embodiment, the system 100 may be utilized to create and track statistics regarding exchanges of rights and responsibilities. For example, a group member who frequently requests exchanges of rights or responsibilities may be cautioned to improve performance or to decrease the number of exchanges. Similarly, a group member who consistently steps forward and accepts exchanges to fulfill additional responsibilities may be congratulated or rewarded for outstanding performance.

In yet another alternative embodiment, the system 100 may track additional statistics related to exchanges. For example, an administrator can assign points to each right or responsibility where the point value indicates the desirability of a right or responsibility. The higher the desirability of the right, the higher the points associated with that right. The higher the desirability of a responsibility, the higher the points associated with that responsibility. As rights and responsibilities are exchanged, the system 100 tracks the relative point values and establishes surplus or deficit point values in accounts associated with each group member. For example, the exchange of a high desirability responsibility for a lower desirability responsibility will result in point values being assigned to various group members. In essence, the system tracks which group members owe another group member(s) a favor. For example, if Group Member A has a desirable 8:00 a.m.-4:00 p.m. office shift (with a high point value) on Tuesday and agrees to exchange with Group Member B for a challenging 8:00 p.m.-4:00 a.m. manufacturing shift (with low point value) on Saturday night, Group Member B would essentially owe Group Member A because Group Member A gave up an easy shift to take on a challenging shift. Group Member A would have a point value surplus with respect to Group Member B and Group Member B would have a deficit point value with respect to Group Member A. The surpluses and deficits can be calculated by subtracting the points of a responsibility taken on by a group member from the points of the responsibility given up by a group member. In this manner, group members who consistently take on challenges and additional responsibilities can be rewarded.

In yet another alternative embodiment, the system 100 may allow designated group members to act on behalf of (i.e., as a proxy for) ether group members who are either unable or unwilling to utilize the system 100. In such situations, proxy group members acting on behalf of ether group members may, among ether tasks, request that replacements be located, request that exchanges be located, specify replacements, specify exchanges, confirm exchange requests, approve exchanges, select group members with which to exchange rights and responsibilities, and update user information or contact information.

The foregoing description refers to the exchange of rights and responsibilities. However, those skilled in the art can appreciate that the term “rights” can be used generally to describe rights and responsibilities. For example, employment at a particular job assignment can be viewed as a responsibility or viewed as a right to an employment opportunity. Similarly, a speaking engagement can be viewed as a right to a speaking opportunity rather than a responsibility. For purposes of the following claims, the term “rights” can be used to refer to rights and responsibilities.

The foregoing described embodiments depict different components contained within, or connected with, different ether components. It is to be understood that such depicted architectures are merely exemplary, and that in fact many ether architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each ether such that the desired functionality is achieved, irrespective of architectures or intermedial components. Likewise, any two components so associated can also be viewed as being “operably connected”, or “operably coupled”, to each ether to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without ether modifiers, typically means at least two recitations, or two or more recitations).

1. A computer-enabled method for the transfer of rights among group members, comprising:
generating a set of proposed transfers of rights based on a set of rights currently possessed by a first group member, the set of proposed transfers of rights providing an acceptable match with rights transfer criteria;
accepting input from the first group member to generate a first set of provisionally accepted transfers of rights;
accepting input from a second group member to generate a second set of provisionally accepted transfers of rights;
generating a set of accepted transfers of rights, the set of accepted transfers of rights comprising transfers of rights contained in both the first and second sets of provisionally accepted transfers of rights; and
executing a transfer to change the rights possessed by the first group member within the set of accepted transfers of rights to the possession of the second group member.

2. The method of claim 1 wherein one or more transfers of rights between the first group member and the second group member provide the acceptable match with the rights transfer criteria and generating the set of proposed transfers of rights comprises evaluating all possible transfers of rights between the first group member and the second group member and selecting the transfers that provide the acceptable match with the rights transfer criteria.

3. The method of claim 1, further comprising defining the rights transfer criteria utilized to determine if transfers of rights provide the acceptable match.

4. The method of claim 1 wherein the rights transfer criteria comprises a qualifications list indicating the qualifications required for the acceptable match with the rights transfer criteria.

5. The method of claim 4 wherein the qualifications list comprises a skill list indicating skills required for the acceptable match with the rights transfer criteria.

6. The method of claim 1 wherein the rights transfer criteria comprises time constraints, compliance with the time constraints being required for the acceptable match with the rights transfer criteria.

7. The method of claim 1 wherein at least a portion of the rights transfer criteria is specified by a third party and the acceptable match with the rights transfer criteria includes an acceptable match with the rights transfer criteria specified by the third party.

8. The method of claim 1 wherein the first group member is an individual.

9. The method of claim 1 wherein the first group member comprises a plurality of individuals.

10. The method of claim 9 wherein one or more transfers of rights between ones of the plurality of individuals and the second group member provide the acceptable match with the rights transfer criteria and generating the set of proposed transfers of rights comprises evaluating all possible transfers of rights between ones of the plurality of individuals and the second group member and selecting the transfers that provide the acceptable match with the rights transfer criteria.

11. The method of claim 10 wherein the set of proposed transfers of rights is generated by evaluating all possible transfers of rights between ones of the plurality of individuals and the second group member and accepting input from the first group member comprises accepting input from ones of the plurality of individuals to generate the first set of provisionally accepted transfers of rights.

12. The method of claim 1 wherein the second group member is an individual.

13. The method of claim 1 wherein the second group member comprises a plurality of individuals.

14. The method of claim 13 wherein one or more transfers of rights between the first group member and ones of the plurality of individuals provide the acceptable match with the rights transfer criteria and generating the set of proposed transfers of rights comprises evaluating all possible transfers of rights between the first group member and ones of the plurality of individuals and selecting the transfers that provide the acceptable match with the rights transfer criteria.

15. The method of claim 14 wherein the set of proposed transfers of rights is generated by evaluating all possible transfers of rights between the first group member and ones of the plurality of individuals and accepting input from the second group member comprises accepting input from ones of the plurality of individuals to generate the second set of provisionally accepted transfers of rights.

16. The method of claim 1 wherein the first group member is specified by the second group member.

17. The method of claim 1 wherein the first group member is selected automatically from a plurality of group members, one or more transfers of rights between the first group member and the second group member providing the acceptable match with the rights transfer criteria.

18. The method of claim 1 wherein the second group member is specified by the first group member.

19. The method of claim 1 wherein the second group member is selected automatically from a plurality of group members, one or more transfers of rights between the first group member and the second group member providing the acceptable match with the rights transfer criteria.

20. The method of claim 1 wherein the input from the first group member specifies the transfers of rights from the set of proposed transfers of rights to thereby generate the first set of provisionally accepted transfers of rights and the input from the second group member specifies the transfers of rights from the first set of provisionally accepted transfers of rights to thereby generate the second set of provisionally accepted transfers of rights.

21. The method of claim 1 wherein the input from the second group member specifies the transfers of rights from the set of proposed transfers of rights to thereby generate the second set of provisionally accepted transfers of rights and the input from the first group member specifies the transfers of rights from the second set of provisionally accepted transfers of rights to thereby generate the first set of provisionally accepted transfers of rights.

22. The method of claim 1 wherein the input from the first group member specifies the transfers of rights from the set of proposed transfers of rights to thereby generate the first set of provisionally accepted transfers of rights and the input from the second group member specifies the transfers of rights from the set of proposed transfers of rights to thereby generate the second set of provisionally accepted transfers of rights.

23. The method of claim 1 wherein the input from the first group member manually selects zero or more transfers of rights, the zero or more transfers of rights being used to generate the first set of provisionally accepted transfers of rights.

24. The method of claim 1 wherein the input from the first group member comprises selection instructions that are used to automatically select zero or more transfers of rights, the zero or more transfers of rights being used to generate the first set of provisionally accepted transfers of rights.

25. The method of claim 1 wherein the input from the second group member manually selects zero or more transfers of rights, the zero or more transfers of rights being used to generate the second set of provisionally accepted transfers of rights.

26. The method of claim 1 wherein the input from the second group member comprises selection instructions that are used to automatically select zero or more transfers of rights, the zero or more transfers of rights being used to generate the second set of provisionally accepted transfers of rights.

27. The method of claim 1 wherein the rights are employment opportunities and changing the rights possessed by the first group member within the set of accepted transfers of rights to the possession of the second group member requires the second group member to fulfill responsibilities related to the employment opportunities.

28. A computer-enabled method for exchanging rights among group members, comprising:
generating a set of proposed exchanges of rights based on a set of rights currently possessed by a first group member and a set of rights currently possessed by a second group member, the set of proposed exchanges of rights providing an acceptable match with rights exchange criteria;
accepting input from the first group member to generate a first set of provisionally accepted exchanges of rights;
accepting input from the second group member to generate a second set of provisionally accepted exchanges of rights;
generating a set of accepted exchanges of rights, the set of accepted exchanges of rights comprising exchanges of rights contained in both the first and second sets of provisionally accepted exchanges of rights; and
executing an exchange to change the rights possessed by the first group member within the set of accepted exchanges of rights to the possession of the second group member and to change the rights possessed by the second group member within the set of accepted exchanges of rights to the possession of the first group member.

29. The method of claim 28 wherein one or more exchanges of rights between the first group member and the second group member provide the acceptable match with the rights exchange criteria and generating the set of proposed exchanges of rights comprises evaluating all possible exchanges of rights between the first group member and the second group member and selecting the exchanges that provide the acceptable match with the rights exchange criteria.

30. The method of claim 28, further comprising defining the rights exchange criteria utilized to determine if exchanges of rights provide the acceptable match.

31. The method of claim 28 wherein the rights exchange criteria comprises a qualifications list indicating the qualifications required for the acceptable match with the rights exchange criteria.

32. The method of claim 31 wherein the qualifications list comprises a skill list indicating skills required for the acceptable match with the rights exchange criteria.

33. The method of claim 28 wherein the rights exchange criteria comprises time constraints, compliance with the time constraints being required for the acceptable match with the rights exchange criteria.

34. The method of claim 28 wherein at least a portion of the rights exchange criteria is specified by a third party and the acceptable match with the rights exchange criteria includes an acceptable match with the rights exchange criteria specified by the third party.

35. The method of claim 28 wherein the first group member is an individual.

36. The method of claim 28 wherein the first group member comprises a plurality of individuals.

37. The method of claim 36 wherein one or more exchanges of rights between ones of the plurality of individuals and the second group member provide the acceptable match with the rights exchange criteria and generating the set of proposed exchanges of rights comprises evaluating all possible exchanges of rights between ones of the plurality of individuals and the second group member and selecting the exchanges that provide the acceptable match with the rights exchange criteria.

38. The method of claim 37 wherein the set of proposed exchanges of rights is generated by evaluating all possible exchanges of rights between ones of the plurality of individuals and the second group member and accepting input from the first group member comprises accepting input from ones of the plurality of individuals to generate the first set of provisionally accepted exchanges of rights.

39. The method of claim 28 wherein the second group member is an individual.

40. The method of claim 28 wherein the second group member comprises a plurality of individuals.

41. The method of claim 40 wherein one or more exchanges of rights between the first group member and ones of the plurality of individuals provide the acceptable match with the rights exchange criteria and generating the set of proposed exchanges of rights comprises evaluating all possible exchanges of rights between the first group member and ones of the plurality of individuals and selecting the exchanges that provide the acceptable match with the rights exchange criteria.

42. The method of claim 41 wherein the set of proposed exchanges of rights is generated by evaluating all possible exchanges of rights between the first group member and ones of the plurality of individuals and accepting input from the second group member comprises accepting input from ones of the plurality of individuals to generate the second set of provisionally accepted exchanges of rights.

43. The method of claim 28 wherein the first group member is specified by the second group member.

44. The method of claim 28 wherein the first group member is selected automatically from a plurality of group members, one or more exchanges of rights between the first group member and the second group member providing the acceptable match with the rights exchange criteria.

45. The method of claim 28 wherein the second group member is specified by the first group member.

46. The method of claim 28 wherein the second group member is selected automatically from a plurality of group members, one or more exchanges of rights between the first group member and the second group member providing the acceptable match with the rights exchange criteria.

47. The method of claim 28 wherein the input from the first group member specifies the exchanges of rights from the set of proposed exchanges of rights to thereby generate the first set of provisionally accepted exchanges of rights and the input from the second group member specifies the exchanges of rights from the first set of provisionally accepted exchanges of rights to thereby generate the second set of provisionally accepted exchanges of rights.

48. The method of claim 28 wherein the input from the second group member specifies the exchanges of rights from the set of proposed exchanges of rights to thereby generate the second set of provisionally accepted exchanges of rights and the input from the first group member specifies the exchanges of rights from the second set of provisionally accepted exchanges of rights to thereby generate the first set of provisionally accepted exchanges of rights.

49. The method of claim 28 wherein the input from the first group member specifies the exchanges of rights from the set of proposed exchanges of rights to thereby generate the first set of provisionally accepted exchanges of rights and the input from the second group member specifies the exchanges of rights from the set of proposed exchanges of rights to thereby generate the second set of provisionally accepted exchanges of rights.

50. The method of claim 28 wherein the input from the first group member manually selects zero or more exchanges of rights, the zero or more exchanges of rights being used to generate the first set of provisionally accepted exchanges of rights.

51. The method of claim 28 wherein the input from the first group member comprises selection instructions that are used to automatically select zero or more exchanges of rights, the zero or more exchanges of rights being used to generate the first set of provisionally accepted exchanges of rights.

52. The method of claim 28 wherein the input from the second group member manually selects zero or more exchanges of rights, the zero or more exchanges of rights being used to generate the second set of provisionally accepted exchanges of rights.

53. The method of claim 28 wherein the input from the second group member comprises selection instructions that are used to automatically select zero or more exchanges of rights, the zero or more exchanges of rights being used to generate the second set of provisionally accepted exchanges of rights.

54. The method of claim 28 wherein the rights are employment opportunities and changing the rights possessed by the first group member within the set of accepted exchanges of rights to the possession of the second group member and changing the rights possessed by the second group member within the set of accepted exchanges of rights to the possession of the first group member requires the group members to fulfill responsibilities related to the employment opportunities.

55. A computer-enabled method for exchanging rights among group members, comprising:
submitting an exchange request related to a set of one or more rights currently possessed by a first group member;
generating a set of proposed exchanges of rights based on the set of rights currently possessed by the first group member and a set of zero or more rights currently possessed by a second group member, the set of proposed exchanges of rights providing an acceptable match with rights exchange criteria;
accepting input from the second group member to generate a set of provisionally accepted exchanges of rights based on the set of proposed exchanges of rights;
accepting input from the first group member to generate a set of accepted exchanges of rights based on the set of provisionally accepted exchanges of rights;
executing an exchange to change the rights possessed by the first group member within the set of accepted exchanges of rights to the possession of the second group member and to change the rights possessed by the second group member within the set of accepted exchanges of rights to the possession of the first group member.

56. The method of claim 55, further comprising communicating with a third party for approval and changing the rights possessed by the first group member within the set of accepted exchanges of rights to the possession of the second group member and changing the rights possessed by the second group member within the set of accepted exchanges of rights to the possession of the first group member only upon approval by the third party.

57. The method of claim 56 wherein the third party approval is based on a set of group members whose interaction will be required if the rights possessed by the first group member within the set of accepted exchanges of rights are changed to the possession of the second group member and the rights possessed by the second group member within the set of accepted exchanges of rights are changed to the possession of the first group member.

58. The method of claim 56 wherein the third party approval is based on a set of customers whose interaction will be required if the rights possessed by the first group member within the set of accepted exchanges of rights are changed to the possession of the second group member and the rights possessed by the second group member within the set of accepted exchanges of rights are changed to the possession of the first group member.

59. The method of claim 55 wherein if the first group member or the second group member does not possess qualifications that meet or exceed the rights exchange criteria, the method further comprising communicating with the first group member to indicate an inability to exchange rights.

60. The method of claim 55, further comprising automatic creation of a schedule listing rights possessed by group members wherein the first group member submits the exchange request based on the schedule listing.

61. The method of claim 60, further comprising automatically altering the schedule listing to indicate changing the rights possessed by the first group member within the set of accepted exchanges of rights to the possession of the second group member and changing the rights possessed by the second group member within the set of accepted exchanges of rights to the possession of the first group member.

62. The method of claim 55 wherein the set of proposed exchanges of rights is generated by evaluating all possible exchanges of rights between the first group member and the second group member and selecting the exchanges where the first group member and second group member possess qualifications that meet or exceed the rights exchange criteria.

63. The method of claim 55 wherein the set of proposed exchanges of rights is generated by evaluating all possible exchanges of rights between the first group member and ones of a plurality of second group members and selecting the exchanges where the first group member and ones of the plurality of second group members possess qualifications that meet or exceed the rights exchange criteria.

64. The method of claim 63 wherein the set of proposed exchanges of rights is generated by evaluating all possible exchanges of rights between the first group member and ones of the plurality of second group members and accepting input from the second group member comprises accepting input from ones of the plurality of second group members to generate the set of provisionally accepted exchanges of rights based on the set of proposed exchanges of rights.

65. The method of claim 55 wherein the rights exchange criteria comprises a qualifications list indicating the qualifications required to meet or exceed the rights exchange criteria.

66. The method of claim 65 wherein the qualifications list comprises a skill list indicating skills required to meet or exceed the rights exchange criteria.

67. The method of claim 65 wherein the qualifications list comprises time constraints, compliance with the time constraints being required to meet or exceed the rights exchange criteria.

68. The method of claim 55 wherein changing the rights possessed by the first group member within the set of accepted exchanges of rights to the possession of the second group member and changing the rights possessed by the second group member within the set of accepted exchanges of rights to the possession of the first group member creates a conflict with a second set of one or more rights currently possessed by the second group member, the method further comprising:
submitting an additional exchange request related to the second set of one or more rights currently possessed by the second group member;
generating a second set of proposed exchanges of rights based on the second set of rights currently possessed by the second group member and a set of zero or more rights currently possessed by a third group member, the second set of proposed exchanges of rights providing an acceptable match with rights exchange criteria;
accepting input from the third group member to generate a second set of provisionally accepted exchanges of rights based on the second set of proposed exchanges of rights;
accepting input from the second group member to generate a second set of accepted exchanges of rights based on the second set of provisionally accepted exchanges of rights;
executing an exchange to change the rights possessed by the second group member within the second set of accepted exchanges of rights to the possession of the third group member and to change the rights possessed by the third group member within the second set of accepted exchanges of rights to the possession of the second group member.

69. The method of claim 55 wherein changing the rights possessed by the first group member within the set of accepted exchanges of rights to the possession of the second group member and changing the rights possessed by the second group member within the set of accepted exchanges of rights to the possession of the first group member creates a conflict with a second set of one or more rights currently possessed by the first group member, the method further comprising:
submitting an additional exchange request related to the second set of one or more rights currently possessed by the first group member;
generating a second set of proposed exchanges of rights based on the second set of rights currently possessed by the first group member and a set of zero or more rights currently possessed by a third group member, the second set of proposed exchanges of rights providing an acceptable match with rights exchange criteria;
accepting input from the third group member to generate a second set of provisionally accepted exchanges of rights based on the second set of proposed exchanges of rights;
accepting input from the first group member to generate a second set of accepted exchanges of rights based on the second set of provisionally accepted exchanges of rights;
executing an exchange to change the rights possessed by the first group member within the second set of accepted exchanges of rights to the possession of the third group member and to change the rights possessed by the third group member within the second set of accepted exchanges of rights to the possession of the first group member.

70. A computer-readable media comprising computer instructions that control one or more computers for the transfer of rights among group members, by:
generating a set of proposed transfers of rights based on a set of rights currently possessed by a first group member, the set of proposed transfers of rights providing an acceptable match with rights transfer criteria;
accepting input from the first group member to generate a first set of provisionally accepted transfers of rights;
accepting input from a second group member to generate a second set of provisionally accepted transfers of rights;
generating a set of accepted transfers of rights, the set of accepted transfers of rights comprising transfers of rights contained in both the first and second sets of provisionally accepted transfers of rights; and
executing a transfer to change the rights possessed by the first group member within the set of accepted transfers of rights to the possession of the second group member.

71. The computer-readable media of claim 70 wherein one or more transfers of rights between the first group member and the second group member provide the acceptable match with the rights transfer criteria and generating the set of proposed transfers of rights comprises evaluating all possible transfers of rights between the first group member and the second group member and selecting the transfers that provide the acceptable match with the rights transfer criteria.

72. The computer-readable media of claim 70 wherein the rights transfer criteria comprises a qualifications list indicating the qualifications required for the acceptable match with the rights transfer criteria.

73. The computer-readable media of claim 70 wherein at least a portion of the rights transfer criteria is specified by a third party and the acceptable match with the rights transfer criteria includes an acceptable match with the rights transfer criteria specified by the third party.

74. The computer readable media of claim 70 wherein the first group member is an individual.

75. The computer readable media of claim 70 wherein the first group member comprises a plurality of individuals.

76. The computer readable media of claim 75 wherein one or more transfers of rights between ones of the plurality of individuals and the second group member provide the acceptable match with the rights transfer criteria and generating the set of proposed transfers of rights comprises evaluating all possible transfers of rights between ones of the plurality of individuals and the second group member and selecting the transfers that provide the acceptable match with the rights transfer criteria.

77. The computer readable media of claim 76 wherein the set of proposed transfers of rights is generated by evaluating all possible transfers of rights between ones of the plurality of individuals and the second group member and accepting input from the first group member comprises accepting input from ones of the plurality of individuals to generate the first set of provisionally accepted transfers of rights.

78. The computer readable media of claim 70 wherein the second group member is an individual.

79. The computer readable media of claim 70 wherein the second group member comprises a plurality of individuals.

80. The computer readable media of claim 79 wherein one or more transfers of rights between the first group member and ones of the plurality of individuals provide the acceptable match with the rights transfer criteria and generating the set of proposed transfers of rights comprises evaluating all possible transfers of rights between the first group member and ones of the plurality of individuals and selecting the transfers that provide the acceptable match with the rights transfer criteria.

81. The computer readable media of claim 80 wherein the set of proposed transfers of rights is generated by evaluating all possible transfers of rights between the first group member and ones of the plurality of individuals and accepting input from the second group member comprises accepting input from ones of the plurality of individuals to generate the second set of provisionally accepted transfers of rights.

82. The computer readable media of claim 70 wherein the first group member is specified by the second group member.

83. The computer readable media of claim 70 wherein the first group member is selected automatically from a plurality of group members, one or more transfers of rights between the first group member and the second group member providing the acceptable match with the rights transfer criteria.

84. The computer readable media of claim 70 wherein the second group member is specified by the first group member.

85. The computer readable media of claim 70 wherein the second group member is selected automatically from a plurality of group members, one or more transfers of rights between the first group member and the second group member providing the acceptable match with the rights transfer criteria.

86. The computer readable media of claim 70 wherein the input from the first group member specifies the transfers of rights from the set of proposed transfers of rights to thereby generate the first set of provisionally accepted transfers of rights and the input from the second group member specifies the transfers of rights from the first set of provisionally accepted transfers of rights to thereby generate the second set of provisionally accepted transfers of rights.

87. The computer readable media of claim 70 wherein the input from the second group member specifies the transfers of rights from the set of proposed transfers of rights to thereby generate the second set of provisionally accepted transfers of rights and the input from the first group member specifies the transfers of rights from the second set of provisionally accepted transfers of rights to thereby generate the first set of provisionally accepted transfers of rights.

88. The computer readable media of claim 70 wherein the input from the first group member specifies the transfers of rights from the set of proposed transfers of rights to thereby generate the first set of provisionally accepted transfers of rights and the input from the second group member specifies the transfers of rights from the set of proposed transfers of rights to thereby generate the second set of provisionally accepted transfers of rights.

89. The computer readable media of claim 70 wherein the input from the first group member manually selects zero or more transfers of rights, the zero or more transfers of rights being used to generate the first set of provisionally accepted transfers of rights.

90. The computer readable media of claim 70 wherein the input from the first group member comprises selection instructions that are used to automatically select zero or more transfers of rights, the zero or more transfers of rights being used to generate the first set of provisionally accepted transfers of rights.

91. The computer readable media of claim 70 wherein the input from the second group member manually selects zero or more transfers of rights, the zero or more transfers of rights being used to generate the second set of provisionally accepted transfers of rights.

92. The computer readable media of claim 70 wherein the input from the second group member comprises selection instructions that are used to automatically select zero or more transfers of rights, the zero or more transfers of rights being used to generate the second set of provisionally accepted transfers of rights.

93. A computer-readable media comprising computer instructions that control one or more computers for the exchange of rights among group members, by:
generating a set of proposed exchanges of rights based on a set of rights currently possessed by a first group member and a set of rights currently possessed by a second group member, the set of proposed exchanges of rights providing an acceptable match with rights exchange criteria;
accepting input from the first group member to generate a first set of provisionally accepted exchanges of rights;
accepting input from the second group member to generate a second set of provisionally accepted exchanges of rights;
generating a set of accepted exchanges of rights, the set of accepted exchanges of rights comprising exchanges of rights contained in both the first and second sets of provisionally accepted exchanges of rights; and
executing an exchange to change the rights possessed by the first group member within the set of accepted exchanges of rights to the possession of the second group member and to change the rights possessed by the second group member within the set of accepted exchanges of rights to the possession of the first group member.

94. The computer-readable media of claim 93 wherein one or more exchanges of rights between the first group member and the second group member provide the acceptable match with the rights exchange criteria and generating the set of proposed exchanges of rights comprises evaluating all possible exchanges of rights between the first group member and the second group member and selecting the exchanges that provide the acceptable match with the rights exchange criteria.

95. The computer-readable media of claim 93 wherein the rights exchange criteria comprises a qualifications list indicating the qualifications required for the acceptable match with the rights exchange criteria

96. The computer-readable media of claim 93 wherein at least a portion of the rights exchange criteria is specified by a third party and the acceptable match with the rights exchange criteria includes an acceptable match with the rights exchange criteria specified by the third party.

97. The computer-readable media of claim 93 wherein the first group member is an individual.

98. The computer-readable media of claim 93 wherein the first group member comprises a plurality of individuals.

99. The computer-readable media of claim 98 wherein one or more exchanges of rights between ones of the plurality of individuals and the second group member provide the acceptable match with the rights exchange criteria and generating the set of proposed exchanges of rights comprises evaluating all possible exchanges of rights between ones of the plurality of individuals and the second group member and selecting the exchanges that provide the acceptable match with the rights exchange criteria.

100. The computer-readable media of claim 99 wherein the set of proposed exchanges of rights is generated by evaluating all possible exchanges of rights between ones of the plurality of individuals and the second group member and accepting input from the first group member comprises accepting input from ones of the plurality of individuals to generate the first set of provisionally accepted exchanges of rights.

101. The computer-readable media of claim 93 wherein the second group member is an individual.

102. The computer-readable media of claim 93 wherein the second group member comprises a plurality of individuals.

103. The computer-readable media of claim 102 wherein one or more exchanges of rights between the first group member and ones of the plurality of individuals provide the acceptable match with the rights exchange criteria and generating the set of proposed exchanges of rights comprises evaluating all possible exchanges of rights between the first group member and ones of the plurality of individuals and selecting the exchanges that provide the acceptable match with the rights exchange criteria.

104. The computer-readable media of claim 103 wherein the set of proposed exchanges of rights is generated by evaluating all possible exchanges of rights between the first group member and ones of the plurality of individuals and accepting input from the second group member comprises accepting input from ones of the plurality of individuals to generate the second set of provisionally accepted exchanges of rights.

105. The computer-readable media of claim 93 wherein the first group member is specified by the second group member.

106. The computer-readable media of claim 93 wherein the first group member is selected automatically from a plurality of group members, one or more exchanges of rights between the first group member and the second group member providing the acceptable match with the rights exchange criteria.

107. The computer-readable media of claim 93 wherein the second group member is specified by the first group member.

108. The computer-readable media of claim 93 wherein the second group member is selected automatically from a plurality of group members, one or more exchanges of rights between the first group member and the second group member providing the acceptable match with the rights exchange criteria.

109. The computer-readable media of claim 93 wherein the input from the first group member specifies the exchanges of rights from the set of proposed exchanges of rights to thereby generate the first set of provisionally accepted exchanges of rights and the input from the second group member specifies the exchanges of rights from the first set of provisionally accepted exchanges of rights to thereby generate the second set of provisionally accepted exchanges of rights.

110. The computer-readable media of claim 93 wherein the input from the second group member specifies the exchanges of rights from the set of proposed exchanges of rights to thereby generate the second set of provisionally accepted exchanges of rights and the input from the first group member specifies the exchanges of rights from the second set of provisionally accepted exchanges of rights to thereby generate the first set of provisionally accepted exchanges of rights.

111. The computer-readable media of claim 93 wherein the input from the first group member specifies the exchanges of rights from the set of proposed exchanges of rights to thereby generate the first set of provisionally accepted exchanges of rights and the input from the second group member specifies the exchanges of rights from the set of proposed exchanges of rights to thereby generate the second set of provisionally accepted exchanges of rights.

112. The computer-readable media of claim 93 wherein the input from the first group member manually selects zero or more exchanges of rights, the zero or more exchanges of rights being used to generate the first set of provisionally accepted exchanges of rights.

113. The computer-readable media of claim 93 wherein the input from the first group member comprises selection instructions that are used to automatically select zero or more exchanges of rights, the zero or more exchanges of rights being used to generate the first set of provisionally accepted exchanges of rights.

114. The computer-readable media of claim 93 wherein the input from the second group member manually selects zero or more exchanges of rights, the zero or more exchanges of rights being used to generate the second set of provisionally accepted exchanges of rights.

115. The computer-readable media of claim 93 wherein the input from the second group member comprises selection instructions that are used to automatically select zero or more exchanges of rights, the zero or more exchanges of rights being used to generate the second set of provisionally accepted exchanges of rights.

116. A system using computers for the transfer of rights among group members, comprising:
a transfer request related to a set of one or more rights currently possessed by a first group member;
a first data structure to store candidate qualification data related to a second group member;
a second data structure to store rights transfer criteria associated with the set of rights possessed by the first group member;
a candidate selection processor to determine if the second group member possesses qualifications that meet or exceed rights transfer criteria associated with the set of rights possessed by the first group member, the candidate selection processor generating a set of proposed transfers of rights if the second group member possesses qualifications that meet or exceed the rights transfer criteria;
a communication interface to accept input from the first group member to generate a first set of provisionally accepted transfers of rights, the communication interface further configured to accept input from the second group member to generate a second set of provisionally accepted transfers of rights, the candidate selection processor generating a set of accepted transfers of rights comprising transfers of rights contained in both the first and second sets of provisionally accepted transfers of rights and changing the rights possessed by the first group member within the set of accepted transfers of rights to the possession of the second group member.

117. The system of claim 116, further comprising a scheduler configured to create a schedule listing rights possessed by group members wherein the first group member submits the transfer request based on the schedule listing.

118. The system of claim 116 wherein the first data structure is configured to store candidate qualification data for a plurality of group members and the candidate selection processor is further configured to evaluate stored candidate qualification data for the plurality of group members to create a pool of group members possessing qualifications that meet or exceed rights transfer criteria associated with the set of rights possessed by the first group member, the candidate selection processor generating the set of proposed transfers of rights for the pool of group members.

119. The system of claim 118 wherein the communication interface is further configured to accept input from ones of the pool of group members to generate the second set of provisionally accepted transfers of rights.

120. The system of claim 116 wherein the communication interface is configured to accept input from the first group member that specifies the transfers of rights from the set of proposed transfers of rights to thereby generate the first set of provisionally accepted transfers of rights and is configured to accept input from the second group member that specifies the transfers of rights from the first set of provisionally accepted transfers of rights to thereby generate the second set of provisionally accepted transfers of rights.

121. The system of claim 116 wherein the communication interface is configured to accept input from the second group member that specifies the transfers of rights from the set of proposed transfers of rights to thereby generate the second set of provisionally accepted transfers of rights and is configured to accept input from the first group member that specifies the transfers of rights from the second set of provisionally accepted transfers of rights to thereby generate the first set of provisionally accepted transfers of rights.

122. The system of claim 116 wherein the communication interface is configured to accept input from the first group member that specifies the transfers of rights from the set of proposed transfers of rights to thereby generate the first set of provisionally accepted transfers of rights and is configured to accept input from the second group member that specifies the transfers of rights from the set of proposed transfers of rights to thereby generate the second set of provisionally accepted transfers of rights.

123. The system of claim 116, further comprising an administrative control module to specify third party rights transfer criteria, the candidate selection processor further configured to utilize the third party rights transfer criteria generate the set of proposed transfers of rights.

124. A system using computers for the exchange of rights among group members, comprising:
an exchange request related to a set of one or more rights currently possessed by a first group member;
a first data structure to store candidate qualification data related to the group members;
a second data structure to store rights exchange criteria associated with rights possessed by the group members;
a candidate selection processor to determine if a second group member possesses qualifications that meet or exceed rights exchange criteria associated with the set of rights possessed by the first group member and to determine if the first group member possesses qualifications that meet or exceed rights exchange criteria associated with rights possessed by the second group member, the candidate selection processor generating a set of proposed exchanges of rights if the second group member possesses qualifications that meet or exceed the rights exchange criteria associated with the set of rights possessed by the first group member and the first group member possesses qualifications that meet or exceed the rights exchange criteria associated with the rights possessed by the second group member;
a communication interface to accept input from the first group member to generate a first set of provisionally accepted exchanges of rights, the communication interface further configured to accept input from the second group member to generate a second set of provisionally accepted exchanges of rights, the candidate selection processor generating a set of accepted exchanges of rights comprising exchanges of rights contained in both the first and second sets of provisionally accepted exchanges of rights and changing the rights possessed by the first group member within the set of accepted exchanges of rights to the possession of the second group member and changing the rights possessed by the second group member within the set of accepted exchanges of rights to the possession of the first group member.

125. The system of claim 124 wherein the first data structure is configured to store candidate qualification data for a plurality of group members and the candidate selection processor is further configured to evaluate stored candidate qualification data for the plurality of group members to determine a pool of group members possessing qualifications that meet or exceed rights exchange criteria associated with the set of rights possessed by the first group member for which the first group member possesses qualifications that meet or exceed rights exchange criteria associated with the rights possessed by the pool of group members, the candidate selection processor generating the set of proposed exchanges of rights for the pool of group members.

126. The system of claim 125 wherein the communication interface is further configured to accept input from ones of the pool of group members to generate the second set of provisionally accepted exchanges of rights.

127. The system of claim 124 wherein the communication interface is configured to accept input from the first group member that specifies the exchanges of rights from the set of proposed exchanges of rights to thereby generate the first set of provisionally accepted exchanges of rights and is configured to accept input from the second group member that specifies the exchanges of rights from the first set of provisionally accepted exchanges of rights to thereby generate the second set of provisionally accepted exchanges of rights.

128. The system of claim 124 wherein the communication interface is configured to accept input from the second group member that specifies the exchanges of rights from the set of proposed exchanges of rights to thereby generate the second set of provisionally accepted exchanges of rights and is configured to accept input from the first group member that specifies the exchanges of rights from the second set of provisionally accepted exchanges of rights to thereby generate the first set of provisionally accepted exchanges of rights.

129. The system of claim 124 wherein the communication interface is configured to accept input from the first group member that specifies the exchanges of rights from the set of proposed exchanges of rights to thereby generate the first set of provisionally accepted exchanges of rights and is configured to accept input from the second group member that specifies the exchanges of rights from the set of proposed exchanges of rights to thereby generate the second set of provisionally accepted exchanges of rights.

130. The system of claim 124, further comprising an administrative control module to specify third party rights exchange criteria, the candidate selection processor further configured to utilize the third party rights exchange criteria generate the set of proposed exchanges of rights.
